(19) United States
(12) Patent Application Publication
(10) Pub. No.: US 2016/0362563 A1
(43) Pub. Date: Dec. 15, 2016

(54) FIRE AND SMOLDERING RESISTANT ARTICLE

(71) Applicant: NATIONAL INSTITUTE OF STANDARDS AND TECHNOLOGY, GAITHERSBURG, MD (US)

(72) Inventors: MAURO ZAMMARANO, GAITHERSBURG, MD (US); RICK D. DAVIS, NEW MARKET, MD (US)

(21) Appl. No.: 15/134,649

(22) Filed: Apr. 21, 2016

Related U.S. Application Data
(60) Provisional application No. 62/174,682, filed on Jun. 12, 2015.

(51) Int. Cl. C09D 5/18; D06M 15/643; D06M 11/36; C09D 183/04

(52) U.S. Cl. CPC C09D 5/18; C09D 183/04; D06M 15/643; D06M 11/36; C08K 3/22

(57) ABSTRACT

A fire and smoldering resistant article includes: a fabric; a coating composition to provide resistance to fire and smoldering of the article, the coating composition disposed on the fabric and including: a cross-linked silicone polymer; and a metal hydroxide disposed among the silicone polymer; and a mesh interposed between the fabric and the coating composition, wherein the cross-linked silicone polymer includes: a reaction product of polydimethylsiloxane (PDMS); a reaction product of a hydroxy modified PDMS; a reaction product of a vinyl modified PDMS; or a combination including at least one of the foregoing silicone polymers.

### CROSS REFERENCE TO RELATED APPLICATIONS

This application claims the benefit of U.S. Provisional Patent Application Ser. No. 62/174,682, filed Jun. 12, 2015, the disclosure of which is incorporated herein by reference in its entirety.

### STATEMENT REGARDING FEDERALLY SPONSORED RESEARCH

This invention was made with United States Government support from the National Institute of Standards and Technology. The Government has certain rights in the invention.

### BRIEF DESCRIPTION

Disclosed is a fire and smoldering resistant article comprising: a substrate; and a coating composition to provide resistance to fire and smoldering of the article, the coating composition disposed on the substrate and comprising: a cross-linked silicone polymer; and an inorganic additive disposed among the cross-linked silicone polymer.

Further disclosed is a fire and smoldering resistant article comprising: a fabric; a coating composition to provide resistance to fire and smoldering of the article, the coating composition disposed on the fabric and comprising: a cross-linked silicone polymer; and a metal hydroxide disposed among the silicone polymer; and a mesh interposed between the fabric and the coating composition, wherein the cross-linked silicone polymer comprises: a reaction product of polydimethylsiloxane (PDMS); a reaction product of a hydroxy modified PDMS; a reaction product of a vinyl modified PDMS; or a combination comprising at least one of the foregoing reaction products.

Additionally disclosed is a process for making a fire and smoldering resistant article, the process comprising: providing a cross-linkable silicone polymer; combining an inorganic additive when the cross-linkable silicone polymer; cross-linking the cross-linkable silicone polymer to form a cross-linked silicone polymer and a coating composition comprising: the cross-linked silicone polymer; and the inorganic additive disposed among the cross-linked silicone polymer; and disposing the coating composition on a substrate to form the fire and smoldering resistant article.

### BRIEF DESCRIPTION OF THE DRAWINGS

The following descriptions should not be considered limiting in any way. With reference to the accompanying drawings, like elements are numbered alike.

FIG. 1 shows a fire and smoldering resistant article;

FIG. 2 shows an inorganic additive from the fire and smoldering resistant article shown in FIG. 1;

FIG. 3 shows a cross-linked silicone polymer from the fire and smoldering resistant article shown in FIG. 1;

FIG. 4 shows a fire and smoldering resistant article;

FIG. 5 shows an inorganic additive from the fire and smoldering resistant article shown in FIG. 4;

FIG. 6 shows a perspective view of a fire and smoldering resistant article;

FIG. 7 shows a front view of the fire and smoldering resistant article shown in FIG. 6;

FIG. 8 shows a cross-section along line A-A of the fire and smoldering resistant article shown in FIG. 7;

FIG. 9 shows an exploded view of a fire and smoldering resistant article;

FIG. 10 shows a cross-section of the fire and smoldering resistant article shown in FIG. 9;

FIG. 11 shows a top view of a reinforcing member that includes a mesh;

FIG. 12 shows a top view of a reinforcing member that includes a mesh;

FIG. 13 shows a cured coating composition according to Example 2 after being tested in a micro combustion calorimeter; and

FIG. 14 shows a cured coating composition according to Example 2 after being tested in a micro combustion calorimeter;

FIG. 15 shows a graph of mass versus temperature according to Example 2;

FIG. 16 shows a graph of rigidity for a plurality of samples according to Example 3;

FIG. 17 shows photographs of a back side of a fire and smoldering resistant article according to Example 4;

FIG. 18 shows photographs of a front side of the fire and smoldering resistant article shown in FIG. 17;

FIG. 19 shows a micrograph of the fire and smoldering resistant article shown in FIG. 17;

FIG. 20 shows a graph of intensity versus energy for fire and smoldering resistant article shown in FIG. 17 before combustion;

FIG. 21 shows a graph of intensity versus energy for fire and smoldering resistant article shown in FIG. 17 after combustion;

FIG. 22 shows photograhs of a fabric subjected to a flame from according to Example 5;

FIG. 23 shows a perspective view of a fire and smoldering resistant article according to Example 6;

FIG. 24 shows a side view of the fire and smoldering resistant article shown in FIG. 23;

FIG. 25 shows a photograph of a cigarette disposed on the article according to Example 6;

FIG. 26 shows an enlarged view of the photograph of the cigarette disposed on the article shown in FIG. 25;

FIG. 27 shows a photograph of the article shown in FIG. 25 with a fabric peeled from a foam according to Example 6;

FIG. 28 shows a photograph of the article subjected to testing according to Example 6;

FIG. 29 shows a photograph of a comparative sample subjected to testing according to Example 7;

FIG. 30 shows a graph of infrared absorption versus intensity and photograhs of a pristine substrate and a backcoated substrate according to Example 8;

FIG. 31 shows a photographs of a pristine substrate and a backcoated substrate according to Example 8;

FIG. 32 shows photographs of a pristine fabric mockup and a backcoated fabric mockup during a flame ignition test according to Example 8; and

FIG. 33 shows photographs of a pristine fabric mockup and a backcoated fabric mockup during a cone calorimetry, a graph of heat release rate versus time, and a micrograph of backcoated fabric according to Example 8.

### DETAILED DESCRIPTION

A detailed description of one or more embodiments is presented herein by way of exemplification and not limitation.

It has been discovered that a fire and smoldering resistant article that includes a coating composition disposed on a substrate suppresses smoldering and flammability of the article. The substrate can be a fabric such as a fabric disposed on a covered member. This arrangement is typical in items such as upholstered furniture and other consumer products. The coating composition can be disposed on a back side of the fabric as a backcoating on the substrate. The coating composition does not substantially affect or change face fibers of the fabric in a property such as a color, hand, visual appearance, or combination thereof. The substrate has flexibility that is retained after disposition of the coating composition on the substrate such that the article is as flexible as the substrate in an absence of the coating composition. In some embodiments, the article is slight more rigid but nearly as flexible as the substrate in an absence of the coating composition but retains flexibility effective for its intended purpose, e.g., a fabric cover for furniture.

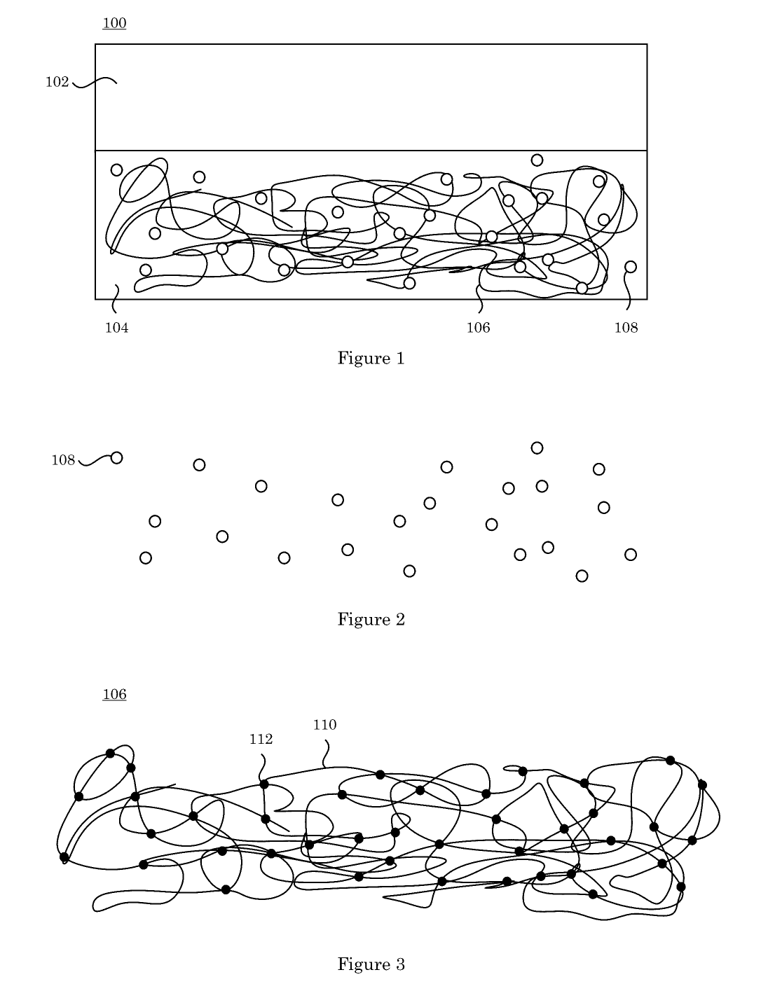

In an embodiment, as shown in FIG. 1 (a cross-section of article 100), fire and smoldering resistant article 100 includes substrate 102 and coating composition 104 disposed on substrate 102. Here, coating composition can be disposed as a backcoating on a back surface of substrate 102, wherein the back surface is opposite a face surface of substrate 102 such as arrangement of a back surface and face of a fabric substrate. In this configuration, the coating composition 104 is also the backcoating for substrate 102. Coating composition 104 provide resistance to fire and smoldering of article 100. Coating composition 104 includes cross-linked silicone polymer 106 and inorganic additive 108 disposed along cross-linked silicone polymer 106. FIG. 2 shows a reproduction of the plurality of inorganic additives 108 show in FIG. 1 in an absence of cross-linked silicone polymer 106. FIG. 3 shows reproduction of cross-linked silicone polymer 106 in an absence of inorganic additive 108. Here, cross-linked silicone polymer 106 includes polymer 110 and cross-links 112 distributed throughout polymer 110. Cross-link 112 binds a portion of polymer 100 can to another portion of polymer 110. In an embodiment, cross-linked silicone polymer 106 includes a plurality of strands of polymer 110. According to an embodiment, cross-linked silicone polymer 106 includes a single strand of polymer 110.

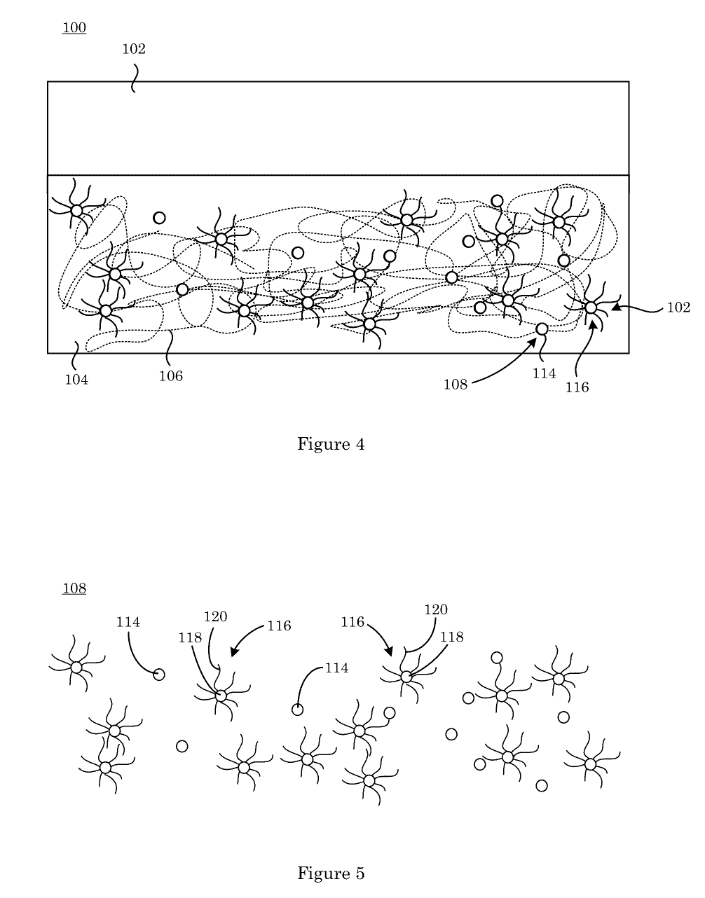

In an embodiment, inorganic additive 108 includes unmodified inorganic additive 114, modified inorganic additive 116, or a combination thereof. In a certain embodiment, inorganic additive 108 in coating composition 104 is unmodified inorganic additive in an absence of modified inorganic 116. In a particular embodiment, inorganic additive 108 in coating composition 104 is modified inorganic additive 116. In some embodiments, inorganic additive 108 in coating composition 104 includes unmodified inorganic additive 114 and modified inorganic additive 116 as shown in FIG. 4. With reference to FIG. 5, modified inorganic additive 116 includes modifier 120 disposed on inorganic additive core 118.

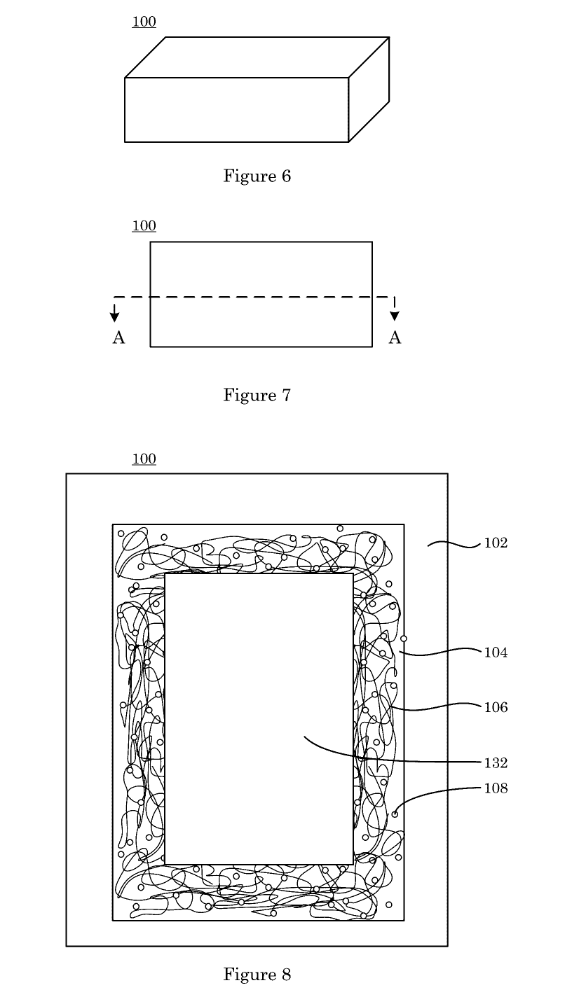

According to an embodiment, with reference to FIG. 6 (perspective view of article 100), FIG. 7 (side view of article 100), and FIG. 8 (cross-section along line A-A shown in FIG. 7 of article 100), article 100 includes substrate 102, coating composition 104 disposed on substrate 102, and covered member 132 upon which substrate 102 and coating composition 104 are disposed. Covered member 132 can have an arbitrary shape, wherein substrate 102 (having coating composition 104 disposed thereon) conforms to the shape of covered member 132. In some embodiments, substrate 102 (having coating composition 104 disposed thereon) has a selected shape and such that substrate 102 accepts covered member 132. In an embodiment, covered member 132 is prepared inside a pocket or internal space bounded by substrate 102 (with coating composition 104 disposed thereon). It is contemplated that coating composition 104 disposed on substrate 102 faces covered member 132.

In an embodiment, coating composition 104 is disposed on a single surface of substrate 102. According to an embodiment, coating composition 104 is disposed on a plurality of surfaces (e.g., opposing faces) of substrate 102.

Article 100 includes substrate 102. Substrate 102 can be any material on which coating composition 104 can be effectively disposed. Exemplary substrates 102 include fabric, paper, leather, and the like, e.g., for protective clothing, draping, bedding, carpeting and other multifunctional barrier materials for flexible structures. The fabric can be knit, woven, nonwoven, and the like. The fabric can include natural or synthetic material such as cotton, wool, silk, flax, polyester, acrylic, nylon, or a combination thereof. The synthetic material is man-made and can be produced from a substance that includes polymers synthesized from chemical compounds, modified or transformed natural polymers, or minerals. The fabric can include various components such as a filament, fiber, yarn, and the like, or a combination thereof. Further, the fabric can be formed, e.g., by weaving, braiding, knitting, warp-knit weft inserting, spin bonding, melt blowing, or other techniques to form structurally integrated masses of filament, fiber, or yarn.

In an embodiment, substrate 102 is an upholstery for covered member 132. The upholstery can include the fabric, laminated fabrics, felt or a combination thereof. The density area density of the substrate can vary between 10 g/m² and 10000 g/m².

Substrate 102 can have a laminate structure, wherein a plurality of layers of material are stacked or bonded together. The layers can include a same or different material, or a layer can be repeated within the laminate. In an embodiment, substrate 102 is a ply such as a carpet, rug, or the like. For the carpet or rug, coating composition 102 can be disposed on an opposite surface of the carpet or rug relative to a pile of the carpet or rug.

Substrate 102 can be part of a consumer goods such as a mattress cover or damask fabric, clothing (e.g., shirt, pants, gloves, and the like), bedding, textiles, draperies, roofing products, drywall material, wall paper, ceiling tile, building insulation, fire barrier materials for flexible structures, and the like.

Article 100 includes coating composition 104 that includes cross-linked silicone polymer 106 and inorganic additive 108. Cross-linked silicone polymer 106 include cross-link 112 among silicone polymer 110. Silicone polymer 110 is a cross-linkable polymer and includes a hydroxy functional group, vinyl functional group, or a combination of the hydroxy functional group and that vinyl functional group, wherein the functional group (i.e., hydroxy functional group or financial can do that vinyl functional group) participates in a cross-linking reaction of silicone polymer 110 to form cross-linked silicone polymer 106. Silicone polymer 110 can be represented as SP-X, wherein SP is a backbone of silicone polymer 110, and X is OH (hydroxy group) or .—CH═CH2 (vinyl functional group, where . is a point of attachment to SP). In an embodiment, silicone polymer includes the vinyl functional group is referred to as a vinyl modified silicone polymer. In an embodiment, silicone polymer 110 includes the hydroxy functional group and is referred to as a hydroxy modified silicone polymer. In some embodiments, silicone polymer 110 includes the vinyl functional group in the hydroxy functional group. A number of functional groups (e.g., the hydroxy social group or vinyl functional group) present in silicone polymer 110 is effective to cross-link silicone polymer 110 to form cross-linked silicone polymer 106.

Silicone polymer 110 (also referred to herein as “cross-linkable silicone polymer” due to a presence of the hydroxy functional group or vinyl functional group) is based on a chemical backbone structure that includes silicon and oxygen atoms (e.g., alternating silicon and oxygen atoms), wherein methyl groups or other lower alkyl groups or phenyl groups are attached to the silicon atoms such that the hydroxy group (also referred to as a silanol group), lower alkyl ether (methoxy silane groups), or vinyl group is attached to silicon atoms (directly or indirectly) and available for taking part in cross-linking silicone polymer 110. Here, the group (e.g., the hydroxy group or vinyl group) is indirectly attached to a silicon atom when an atom or plurality of atoms is present between the group and the silicon atom in the backbone of silicone polymer 110. Alternatively, the group (e.g., the hydroxy group or vinyl group) is directly attached to a silicon atom such that no atom is present between the group and the silicon atom in the backbone of silicone polymer 110. In some embodiments, silicone polymer 110 includes the group attached directly, the group attached indirectly, or a combination of some groups attached directly and some groups attached indirectly to the backbone of the silicone polymer 110. As used herein, “polymer” refers to a molecule having two or more repeat units, including bimers, trimers, oligomers, and the like.

Silicone polymer 110 can be a blend of polymers, copolymers, terpolymers, or combinations comprising at least one of the foregoing silicone polymers. Silicone polymer can also be an oligomer, a homopolymer, a copolymer, a block copolymer, an alternating block copolymer, a random polymer, a random copolymer, a random block copolymer, a graft copolymer, a star block copolymer, a dendrimer, or the like, or a combination comprising at last one of the foregoing silicone polymers. Silicone polymer 110 can be branched, straight chain, dendritic, and the like.

In an embodiment, silicone polymer 110 includes the vinyl terminated silicone polymer. The vinyl terminated silicone polymer can include an average of one or more, e.g., two, silicon-bonded vinyl functional groups per molecule. The number of vinyl functional groups can vary from two per molecule. In an embodiment, silicone polymer 110 includes a plurality of vinyl, terminated silicone polymers in which some molecules have more vinyl functional groups than two per molecule and some have less than two vinyl functional groups per molecule. The vinyl functional group in the vinyl terminated silicone polymer of silicone polymer 110 can be located at any position along the backbone of silicone polymer 110 such as an alpha position, omega position, or other position of silicone polymer 110.

The vinyl terminated silicone polymer can be a linear polymer that can have some branching. The polyorganosiloxanes may have silicon-oxygen-silicon backbones with an average of greater than two organo groups per silicon atom. In an embodiment, silicone polymer 10 is made up of diorganosiloxane units with triorganosiloxane units for end groups, but small amounts of monoorganosiloxane units and SiO₂ units also can be present. Such organo radicals can have less than about 10 carbon atoms per radical and are independently selected from monovalent hydrocarbon radicals such as methyl, ethyl, vinyl, propyl, hexyl, and phenyl and monovalent substituted hydrocarbon radicals, such as the perfluoroalkylethyl radicals. Exemplary vinyl terminated silicone polymers include dimethylvinylsiloxy endblocked polydimethylsiloxane, methylphenylvinylsiloxy endblocked polydimethylsiloxane, dimethylvinylsiloxy endblocked polymethyl-(3,3,3-trifluoropropyl)siloxane, dimethylvinylsiloxy endblocked polydiorganosiloxane copolymers of dimethylsiloxane units and methylphenylsiloxane units, and methylphenylvinylsiloxy endblocked polydiorganosiloxane copolymers of dimethylsiloxane units and diphenylsiloxane units, and the like. The vinyl terminated silicone polymer can have siloxane units such as dimethylsiloxane units, methylphenylsiloxane units, diphenylsiloxane units, methyl-(3,3,3-trifluoropropyl)siloxane units, monomethylsiloxane units, monophenylsiloxane units, dimethylvinylsiloxane units, trimethylsiloxane units, methylphenylvinylsiloxane units, and SiO₂ units. According to an embodiment, vinyl, terminated silicone polymer is a polydimethylsiloxane endblocked with dimethylvinylsiloxy units.

In an embodiment, silicone polymer 110 includes the hydroxy terminated silicone polymer. The hydroxy terminated silicone polymer can include polydimethyl siloxane (PDMS) as the backbone with hydroxy functional groups attached thereto as a hydroxy terminated PDMS.

Hydroxy terminated PDMS can have a structure such as HO(R¹R²SiO)ₙR³, wherein R¹, R², and R³ are independently an alkyl group (e.g., from one to 12 carbon atoms), hydroxyl, aryl group, amine group, amide, carboxyl, epoxy group, carbinol, thiol, vinyl group, alkoxy group; n is an integer selected for a number of repeat units in the hydroxy terminated PDMS, e.g., from two to 100, specifically from 2 to 20. Exemplary alkyl groups include methyl, ethyl, propyl, tert-butyl, and hexyl. Exemplary aryls include phenyl, tolyl, xylyl, and naphthal.

Silicone polymer 110 can be obtained from a commercial source or synthetically prepared. The hydroxy terminated silicone polymer can be made from organochlorosilanes methyltrichiorosilane, phenyltrichlorosilane, or dimethyldichlorosilane) that is reacted with an organic halide (e.g., methyl chloride or chlorobenzene) in presence of silicon and a copper catalyst to produce chlorosilanes that further can be reacted with water to form the hydroxy terminated silicone polymer. Silicone polymer 110 can have a number average molecular weight above 500, specifically from 600 and 8000. A molecular weight of silicone polymer can be determined by gel permeation chromatography (GPC) in accordance with ASTM D3016-72, ASTM D3536-76, ASTM D3593-80, or ASTM D3016-78. Here, the number average molecular weight can be, e.g., 27000.

In an embodiment, silicone polymer 110 is polydimethylsiloxane (PDMS). In a particular embodiment, silicone polymer 110 is the hydroxy modified PDMS. In a certain embodiment, silicone polymer 110 is the vinyl modified PDMS. In some embodiments, silicone polymer 110 is a combination of the hydroxy modified PDMS and vinyl modified PDMS.

In an embodiment, silicone polymer 110 includes a polysilsesquioxane, also referred to as polyorganosilsesquioxane or polyhedral oligomeric silsesquioxane (POSS) derivatives, are polyorganosilicon oxide compounds of general formula RSiO_{1.5} (where R is independently an organic group such as methyl, hydroxyl, or vinyl) having defined closed or open cage structures (closo or nido structures). Poly including POSS structures, may be prepared by acid- or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

According to an embodiment, coating composition 104 includes cross-linked silicone polymer 106 and inorganic additive 108 disposed among cross-linked silicone polymer 106. In an embodiment, cross-linked silicone polymer 106 includes a reaction product of cross-linking the PDMS. In a certain embodiment, cross-linked silicone polymer 106 includes a reaction product of cross-linking a hydroxy modified PDMS. In a particular embodiment, cross-linked silicone polymer includes a reaction product of cross-linking a vinyl modified PDMS. In some embodiments, cross-linked silicone polymer 106 includes a combination of the reaction product of cross-linking the PDMS, the reaction product of cross-linking the hydroxy modified PDMS, or the reaction product of cross-linking the vinyl modified PMS.

In an embodiment, cross-linked silicone polymer 106 is the product of cross-linking PDMS that includes cross-linked PDMS. In a certain embodiment, cross-linked silicone polymer 106 is the reaction product of cross-linking the hydroxy modified PDMS that includes cross-linked hydroxy modified PDMS. In a particular embodiment, cross-linked silicone polymer 106 is the reaction product of cross-linking the vinyl modified PDMS that includes cross-linked vinyl modified PDMS.

For an addition reaction of vinyl modified PDMS, the cross linker be an organohydrogenpolysiloxane that includes a functional hydride group (SiH) that reacts with the vinyl modified PDMS by an addition reaction known as hydrosilation. The organohydrogenpolysiloxane can have the formula RₐH_{b}SiOₓ, wherein a and b are integers from 1 to 1000, and x is an integer equal to (4−a−b)/2. The organohydrogenpolysiloxane is commercially available in two components, a lot-matched base (vinyldimethylsiloxane with a platinum catalyzer and fumed silica as filler) and a curing agent (organohydrogenpolysiloxane, vinyldimethylsiloxane and fumed silica as filler).

For a condensation reaction of hydroxyl modified PDMS (silanols), silanols can be crosslinked in presence of moisture with acetoxy, enoxy, oxime, alkoxy and amine based cure systems. Exemplary crosslinkers include di-t-butixydiacetoxysilane, ethyltriacetoxysilane, methyltraicetoxysilane, tetraethoxysilane, tetra-n-propoxysilane, vinyltriisopropenoxysilane, and the like.

Alkoxides can be used as the crosslinker in presence of a titanate catalyst or a tin catalyst.

Cross-linked silicone polymer 106 can be formed by cross-linking silicone polymer 110. Cross-linking silicone polymer 110 involves curing silicone polymer 106 in a presence of a cross-linker. Exemplary cross-linkers include a surface modifier.

The surface modifier can increase a flexibility of the coating by disrupting an interaction such as hydrogen bonding between a hydroxyl on a surface of the inorganic additive and Si—O—Si moieties in the crosslinked silicone polymer. The surface modifier can interact with the inorganic additive, e.g., by forming a covalent bond.

Exemplary surface modifiers include a silane, titanate, zirconate, organic compound containing an acid, acid precursor (e.g., an anhydride), aluminate, borate, phosphate, and the like. The titanate can have the following structure:

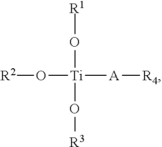

wherein A is halogen or oxygen; R¹, R², R³, and R⁴ are independently hydrogen, optionally substituted alkyl, optionally substituted fluoroalkyl, optionally substituted cycloalkyl, optionally substituted heterocycloalkyl, optionally substituted aryl, optionally substituted aralkyl, optionally substituted heteroaryl, optionally substituted heteroaralkyl, optionally substituted, optionally substituted alkenyl, optionally substituted alkynyl, optionally substituted NH₂, optionally substituted amine, optionally substituted alkyleneamine, optionally substituted aryleneamine, optionally substituted alkenyleneamine; and R⁴ is not present when A is halogen.

Examples of the titanate of formula 1 include titanium(IV) diisopropoxide bis(acetylacetonate); titanium(IV) isopropoxide; titanium(IV) butoxide; titanium(IV) ethoxide; chlorotriisopropoxytitanium(IV); titanium(IV) bis(ammonium lactato)dihydroxide; titanium(IV) tert-butoxide; titanium (IV) 2-ethylhexyloxide; titanium(IV) isopropoxide; titanium (IV) methoxide; titanium (IV) propoxide; titanium(IV) (triethanolaminato)isopropoxide; titanium (IV) 2-ethylhexyloxide; titanium(IV) tetrahydrofulfuryloxide; titanium(IV) diisopropoxide bis(2,2,6,6-tetramethyl-3,5-heptanedionate); titanium(IV) tetra-2-ethylhexanoate; and octylene glycol titanate. The titanate can be selected from one of the aforementioned listed, a derivative thereof, a salt thereof, or a combination thereof.

The zirconate can have the following structure:

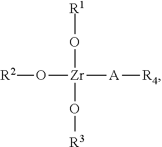

wherein A is halogen or oxygen;
R¹, R², R³, and R⁴ are independently hydrogen, optionally substituted alkyl, optionally substituted fluoroalkyl, optionally substituted cycloalkyl, optionally substituted heterocycloalkyl, optionally substituted aryl, optionally substituted aralkyl, optionally substituted heteroaryl, optionally substituted heteroaralkyl, optionally substituted, optionally substituted alkenyl, optionally substituted alkynyl, optionally substituted NH₂, optionally substituted amine, optionally substituted alkyleneamine, optionally substituted aryleneamine, optionally substituted alkenyleneamine; and
R⁴ is not present when A is halogen.

Examples of the zirconate include zirconium(IV) acetylacetonate; zirconium(IV) acrylate, zirconium(IV) butoxide, zirconium(IV) tert-butoxide, zirconium(IV) carbonate; zirconium(IV) carbonate hydroxide; zirconium(IV) carboxyethyl acrylate, zirconium(IV) diisopropoxide bis(2,2,6,6-tetramethyl-3,5-heptanedionate); zirconium(IV) ethoxide; zirconium(IV) propoxide; zirconium (IV) methoxide; zirconium(IV) acetate hydroxide; zirconium(IV) bis(diethyl citrato)dipropoxide; zirconium(IV) isopropoxide; and zirconium(IV) trifluoroacetylacetonate. The zirconate can be selected from one of the aforementioned listed, a derivative thereof, a salt thereof, or a combination thereof.

The amount of the zirconate or titanate is that amount to sufficiently produce a desired density of crosslinks in cross-linked silicone polymer 106 or to functional a surface of inorganic additive 108. In an embodiment, the titanate (or zirconate) is present in an amount from about 0.01 weight percent (wt. %) to about 10 wt. %, specifically from about 0.05 wt. % to about 5 wt. %, and more specifically about 0.1 wt. % to about 1 wt. %, based on the weight of silicone polymer 110.

The surface modifier includes a reactive group, e.g., one, two, three, four, or more reactive groups. In an embodiment, the surface modifier cross-links silicone polymer 110 to itself or with another silicone polymer 110. According to an embodiment, the surface modifier reacts with inorganic additive 108 to form a chemical bond with inorganic additive 108. In a certain embodiment, the surface modifier reacts react with silicone polymer 110, inorganic additive 108, cross-linked silicone polymer 106, or a combination thereof. Accordingly, the surface modifier bonds cross-linked silicone polymer 106 or silicone polymer 110 to inorganic additive 108, is a cross-linker for silicone polymer 110, or contains reactive groups that can crosslink to form cross-linked silicone polymer 106.

The surface modifier can include various reactive groups. In an embodiment, the surface modifier has a structure provided by formula 1, formula 2, formula 3, formula 3, formula 4, formula 5, or a combination thereof.

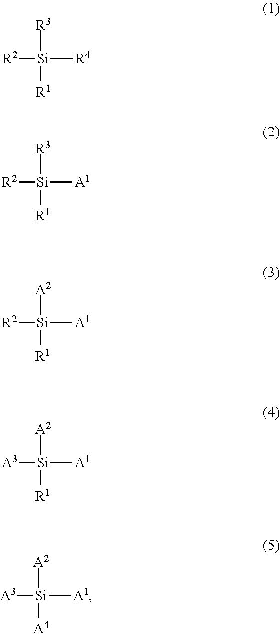

wherein R¹, R², R³, and R⁴ are independently a group that can react and form a chemical bond with inorganic additive 108; and A¹, A², A³, and A⁴ are independently a group that can react and form a chemical bond with silicone polymer 110. Exemplary R¹, R², R³, and R⁴ groups independently include alkyl, alkoxy, and the like. Exemplary A¹, A², A³, and A⁴ groups include vinyl, epoxy, styryl, methacryloxy, acryloxy, amino, ureide, mercapto, sulfide, isocyanate, hydroxy, sulfonyl, carboxyl, and the like.

Exemplary surface modifiers include 2-(3,4 epoxycyclohexyl) ethyltrimethoxysilane; 3-acryloxypropyl trimethoxysilane; 3-aminopropyltriethoxysilane; 3-aminopropyltrimethoxysilane; 3-glycidoxypropyl methyldiethoxysilane; 3-glycidoxypropyl methyldimethoxysilane; 3-glycidoxypropyl triethoxysilane; 3-glycidoxypropyl trimethoxysilane; 3-isocyanatepropyltriethoxysilane; 3-mercaptopropylmethyldimethoxysilane; 3-mercaptopropyltrimethoxysilane; 3-methacryloxypropyl methyldiethoxysilane; 3-methacryloxypropyl methyldimethoxysilane; 3-methacryloxypropyl triethoxysilane; 3-methacryloxypropyl trimethoxysilane; 3-triethoxysilyl-N-(1,3 dimethyl-butylidene) propylamine; 3-ureidopropyltrialkoxysilane; aminopropylmethyldimethoxysilane; aminopropyltrimethoxysilane; aminopropyltrimethoxysilane hydrochloride; bis(triethoxysilylpropyl)tetrasulfide; N-(vinylbenzyl)-2-aminoethyl-3-; N-(vinylbenzyl)-2-aminoethyl-3-aminopropyltrimethoxysilane hydrochloride, hydrolysate; N-2-(aminoethyl)-3-; N-2-(aminoethyl)-3-; N-phenyl-3-aminopropyltrimethoxysilane; p-styryltrimethoxysilane; tris-(trimethoxysilylpropyl)isocyanurate; vinyltriethoxysilane; vinyltrimethoxysilane; and the like.

Additional exemplary surface modifiers include methyltrimethoxysilane; dimethyldimethoxysilane; phenyltrimethoxysilane; methyltriethoxysilane; dimethyldiethoxysilane; phenyltriethoxysilane; n-propyltrimethoxysilane; n-propyltriethoxysilane; hexyltrimethoxysilane; hexyltriethoxysilane; octyltriethoxysilane; decyltrimethoxysilane; 1,6-bis(trimethoxysilyl)hexane; trifluoropropyltrimethoxysilane; hexamethyldisilazane; and the like.

The catalyst promotes crosslinking of silicone. For hydrosilation crosslinking, catalysts based on precious metals like platinum and rhodium can be used. Exemplary catalysts include platinum-carbonyl cyclovinylmethylsiloxane complex, platinum-divinyltetramethyldisiloxane complex, platinum-cyclovinylmethylsiloxane complex, platinum-octanaldehyde/octanol complex, tris(dibutylsulfide)rhodium trichloride.

For condensation crosslinking, catalysts based on titanates in combination with tin compounds and other metal-organics are used. Exemplary catalysts include bis(2-ethylhexanoate)tin, bis(neodecanoate)tin, di-n-butylbis(2-ethylhexylmaleate)tin, di-n-butylbutoxychlorotin, di-n-butyldilauryltin, dioctyldilauryltin, titanium di-n-butoxide, titanium diisopropoxide, titanium trimethylsiloxide.

In an embodiment, coating composition 104 includes inorganic additive 108 disposed among cross-linked silicone polymer 106. Inorganic additive 108 increases the smoldering and flaming combustion resistance. According to an embodiment, inorganic additive 108 includes an inorganic hydroxide. The inorganic hydroxide can include a hydroxyl group attached thereto. In an embodiment, the inorganic hydroxide includes a metal such that the inorganic hydroxide is a metal hydroxide. The metal can be an alkali metal, alkaline earth metal, transition metal, or combination thereof. Exemplary metals include zinc, aluminum, magnesium, and the like. In some embodiments, the inorganic hydroxide includes a nonmetal such that the inorganic hydroxide is a nonmetal hydroxide. The nonmetal can be a metalloid. Exemplary nonmetals include silicon, boron, and the like.

Without wishing to be bound by theory, it is believed that inorganic additive 108 is a flame retardant that decomposes, e.g., endothermically to release water, wherein an oxygen concentration is decreased by dilution to produce a thermally stable and insulating metal oxide or nonmetal oxide from the inorganic hydroxide. The water produced by decomposing the inorganic hydroxide of inorganic additive 108 effects smoldering and flammability. Here, water produced in coating composition 104 condenses on a cold side of substrate 102 when article 100 is subjected to a flame.

Exemplary metal hydroxides include zinc hydroxide, aluminum hydroxide, magnesium hydroxide, magnesium-aluminum layered double hydroxides, and the like. The aluminum hydroxide can be a pristine aluminum hydroxide (ATH) (e.g., sold under the trademark Apyral 40CD and commercially available from Nabaltec), a vinyl silane treated aluminum hydroxide (VS/ATH) (sold under the trademark Apyral 40VS1 and commercially available from Nabaltec), and the like. Relative to ATH, VS/ATH produces an excess of vinyl groups present in inorganic additive 108. Accordingly, a density of cross-links in cross-linked silicone polymer 106 is decreased, and a flexibility of cross-linked silicone polymer 106 is increased without affecting flammability of backcoated article 100. Without wishing to be bound by theory, it is believed that vinyl groups cross-link during thermal degradation of the coating. VS/ATH can improve dispersion of the ATH of inorganic additive 108 among silicone polymer 110.

Exemplary nonmetal hydroxides include silicic acid, boric acid, and the like.

According to an embodiment, inorganic additive 108 includes the surface modifier disposed as modifier 120 on (e.g., bonded to) inorganic additive core 118 (e.g., the metal hydroxide) to form modified inorganic additive 116 (see, e.g., FIG. 4 and FIG. 5). In an embodiment, modified inorganic additive 116 includes vinyltrimethoxysilane as modifier 120 bonded to aluminum hydroxide as inorganic additive core 118 to provide (CH₂═CH)(CH₃O)₂Si-ATH, where ATH is aluminum hydroxide (sometimes referred to as aluminum trihydroxide ATH, wherein Si and ATH are bonded via an oxygen atom. Here, modifier 120 (vinyltrimethoxysilane) is bonded to ATH 118 by a condensation reaction of the hydroxyl groups on the surface of the ATH with the silanol formed by hydrolysis of the silane modifier. Additional modified inorganic additives 116 that include the surface modifier bonded as modifier 120 to the metal hydroxide 118 include fumed silica, calcium carbonate, titanium oxide, and the like.

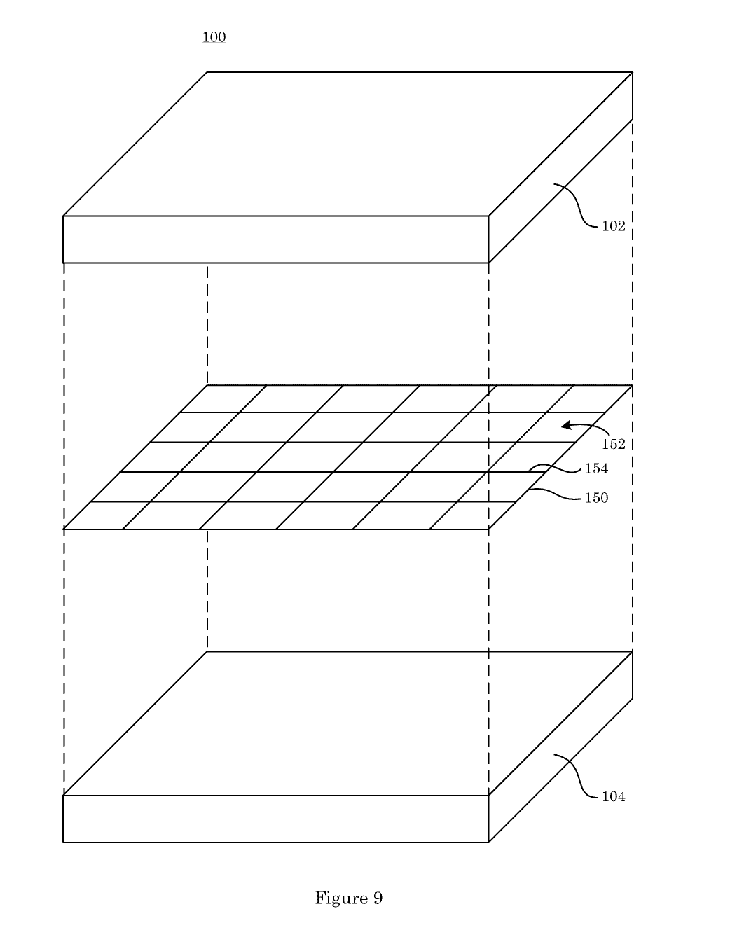

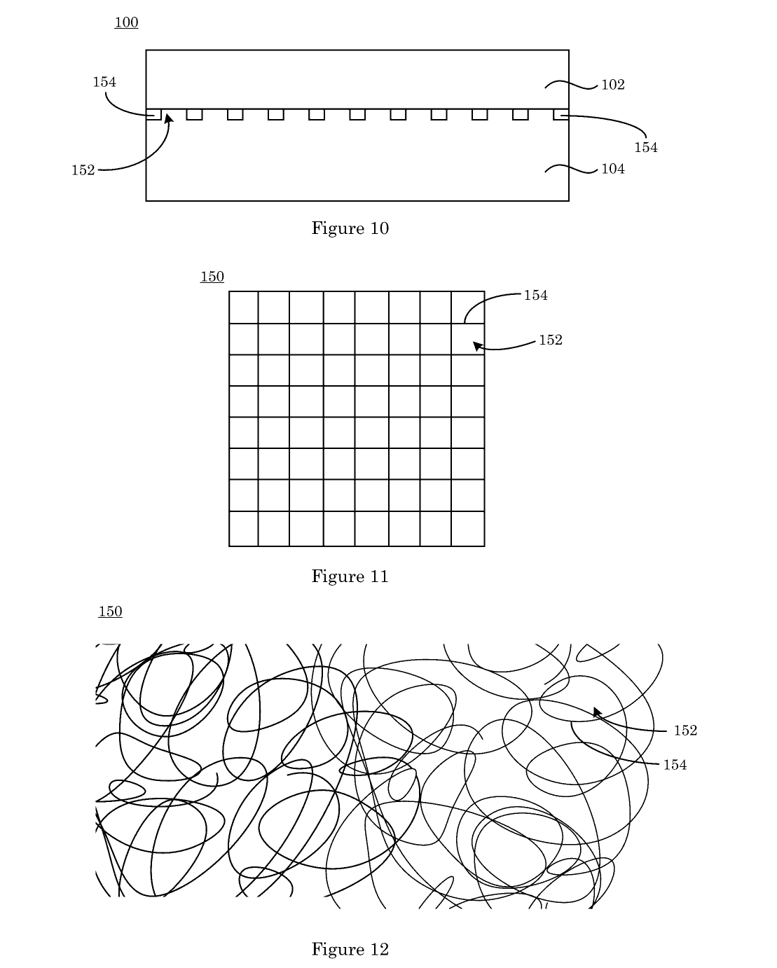

In an embodiment, fire and smoldering resistant article 100 includes reinforcing member 150 interposed between substrate 102 and coating composition 104 as shown in FIG. 9 (an exploded view of article 100) and FIG. 10 (a cross-section of article 100). Reinforcing member 150 can include interstitial gap 152 bounded by mesh material 154. Here, a portion of coating composition 104 is disposed in interstitial gap 152 and contacts substrate 102. According to an embodiment, mesh material 154 is arranged in a matrix format as shown in FIG. 11. In a certain embodiment, mesh material 154 is arranged in a coil format as shown in FIG. 12.

A shape or size of interstitial gap 152 can be any shape effective to communicate coating composition 104 to substrate 102 such that coating composition 104 contacts substrate 102 through interstitial gap 152. Exemplary shapes of interstitial gap 152 include a round, square, oval, polygonal, regular, irregular, and the like. The size (e.g., a largest linear dimension) can be from 5 cm to 5 μm, specifically from 10 mm to 0.1 mm, and more specifically from 5 mm to 1 mm.

Reinforcing member 150 provides mechanical support to substrate 102 so that substrate 102 does not rip, perforate, tear, or the like. Reinforcing member maintains a rigidity of substrate 102. In an embodiment, article 100 has substantially the same rigidity with and without reinforcing member 150. In a particular embodiment, article 100 has an increased rigidity with reinforcing member 150 then without reinforcing member 150.

Exemplary mesh material 152 includes a metal, polymer (e.g., an elastomer, thermoset, thermoplastic, and the like), glass, carbon, or a combination thereof. Exemplary polymers include polyimides, polybenzoxazoles, polybenzimidazoles, and polybenzthiazoles, silicones, phenolics and the like. Exemplary glasses include borosilicate, and the like. Exemplary metals include steel, tungsten and the like.

Coating composition 104 includes cross-linked silicone polymer 106 and inorganic additive 108 disposed among cross-linked silicone polymer 106. Inorganic additive 108 can be present in coating composition 104 in an amount from 5 weight percent (wt %) to 90 wt %, specifically from 20 wt % to 80 wt %, and more specifically from 50 wt % to 75 wt %, based on a total weight of coating composition 104.

A size or shape of inorganic additive 108 can be selected to provide an appropriate size or shape to coating composition 104. Here, the size (e.g., a largest linear dimension) of inorganic additive 108 can be from 0.1 μm to 1 mm, specifically from 1 μm to 100 μm , and more specifically from 10 μm to 80 μm. The shape of inorganic additive 100 can be platelet-like, whisker-like, spherical or irregular. A volume of inorganic additive 108 can be from 2% to 50%, specifically from 10% to 40%, and more specifically from 25% to 35%.

Cross-linked silicone polymer 106 can be present in coating composition 104 in an amount from 5 weight percent (wt %) to 95 wt %, specifically from 10 wt % to 50 wt %, and more specifically from 15 wt % to 30 wt %, based on a total weight of coating composition 104.

A molecular weight of silicone polymer 110 can be from 100 Daltons (D) to 1,000,000 D, specifically from 1000 D to 100,000 D, and more specifically from 20,000 D to 40,000 D, where molecular weight is a the number average molecular weight Mn as determined by ASTM Standard D6579-11(2015) “Standard Practice for Molecular Weight Averages and Molecular Weight Distribution of Hydrocarbon, Rosin and Terpene Resins by Size-Exclusion Chromatography” ASTM International, West Conshohocken, Pa., 2015, DOI: 10.1520/D6579-11R15.

A number density of cross-links 112 in cross-linked silicone polymer 106 can be from effect to provide suppression of flammability and smoldering of the article.

A thickness of coating composition 104 disposed on substrate 102 can be selected so that coating composition 104 provides provide resistance to fire and smoldering of article 100. Here, resistance to fire and smoldering refers to the ability of the coating to prevent flame breakthrough and the oxidation or pyrolysis of the substrate. The thickness of coating composition can be from 1 micrometers (μm) to 1 centimeters (cm), specifically from 10 μm to 5 mm, and more specifically from 0.5 mm to 2 mm. It is contemplated that the thickness of coating composition 104 can be less than 1000%, specifically 500% to 1%, and more specifically 100% to 50% of a thickness of substrate 102.

A thickness of reinforcing member 150 interposed between substrate 102 and coating composition 104 can be selected to maintain a rigidity of substrate 102. The thickness of reinforcing member 150 can be from 1 micrometers (μm) to 1 centimeters (cm), specifically from 10 μm to 1 mm, and more specifically from 50 μm to 500 μm. It is contemplated that the thickness of reinforcing member 150 can be less than 99%, specifically 95% to 5%, and more specifically 90% to 50% of the thickness of coating composition 104.

According to an embodiment, fire and smoldering resistant article 100 includes substrate 100 that includes a fabric; coating composition 104 to provide resistance to fire and smoldering of article 100, coating composition 104 disposed on the fabric and including: cross-linked silicone polymer 106 that includes: a reaction product of cross-linking polydimethylsiloxane (PDMS); a reaction product of cross-linking a hydroxy modified PDMS; a reaction product of cross-linking a vinyl modified PDMS; or a combination including at least one of the foregoing silicone polymers; and a metal hydroxide as inorganic additive 108 disposed among cross-linked silicone polymer 106; and mesh 150 interposed between the fabric and coating composition 104. According to an embodiment, mesh 150 includes interstitial gap 152, and a portion of coating composition 104 is disposed in interstitial gap 152, wherein the portion of coating composition 104 is in contact with the fabric.

In an embodiment, a process for making fire and smoldering resistant article 100 includes: providing cross-linkable silicone polymer 110; combining inorganic additive 108 with cross-linkable silicone polymer 110; cross-linking cross-linkable silicone polymer 110 to form cross-linked silicone polymer 106 and coating composition 104 including: cross-linked silicone polymer 106; and inorganic additive 108 disposed among cross-linked silicone polymer 106; and disposing coating composition 104 on substrate 102 to form fire and smoldering resistant article 100.

In an embodiment, combining inorganic additive 108 with cross-linkable silicone polymer 110 includes dispersing inorganic additive 108 among silicone polymer 110 prior to cross-linking silicone polymer 110. In an embodiment, coating composition 104 was prepared by combining inorganic additive 108 (e.g., 65 wt % ATH or VS/ATH, based on a total weight of coating composition 104) with silicone polymer 110 (e.g., vinyl modified PDMS) using a spatula to form a viscous paste.

In an embodiment, cross-linking of cross-linkable silicone polymer 110 to form cross-linked silicone polymer 106 and coating composition 104 includes combining inorganic additive 108 with silicone polymer 110. Combining can be accomplished, e.g., by mixing with a bladeless mixer at room temperature for a selected time, e.g., 120 seconds.

Cross-linked silicone polymer 106 can be made by reacting various silicone polymers 110. Exemplary polysiloxanes include polydimethylsiloxane (PDMS), polymethyl phenyl siloxane (PMPS), polyvinylmethylsiloxane (PVMS), polyhydroxysiloxane (PHS), polymethylhydroxysiloxane (PMHS), and the like. In the reaction to form cross-linked silicone polymer 106, silicone polymer 110 is subjected to curing that can include peroxide curing, hydrosilation, condensation curing, and the like. Prior to curing, inorganic additive 108 is combined with silicone polymer 110.

According to an embodiment, cross-linked silicone polymer 106 is made by subjecting silicone polymer to peroxide curing. Here, silicone polymer 110 is combined with inorganic additive 108 and a peroxide curing agent to make a reaction composition that is heated to obtain cross-linked silicone polymer 106. Exemplary peroxide curing agents include methyl ethyl ketone peroxide, benzoyl peroxide, acetone peroxide, t-amyl peroxybenzoate, t-hexyl peroxybenzoate, 1,3,3,3-tetramethylbutyl peroxybenzoate, t-amyl peroxy-m-methylbenzoate, t-hexyl peroxy-m-methylbenzoate, 1,1,3,3-tetramethylbutyl peroxy-m-methylbenzoate, t-hexyl peroxy-p-methylbenzoate, t-hexyl peroxy-o-methylbenzoate, t-hexyl peroxy-p-chlorobenzoate, bis(t-hexyl peroxy)phthalate, bis(t-amyl peroxy)isophthalate, bis(t-hexyl peroxy)isophthalate, bis(t-hexyl peroxy)terephthalate, tris(t-hexyl peroxy)trimellitate, 1,1-bis(t-butylperoxy)-3,3,5-trimethylcyclohexane, 1,1-bis(t-hexylperoxy)-3,3,5-trimethylcyclohexane, 1,1-bis(t-hexylperoxy)cyclohexane, 1,1-bis(t-butylperoxy)cyclododecane, 1,1-bis(t-butylperoxy)cyclohexane, 2,2-bis(t-butylperoxy)octane, n-butyl-4,4-bis(t-butylperoxy)butane, n-butyl-4,4-bis(t-butylperoxy)valerate, di-t-butyl peroxide, dicumyl peroxide, t-butyl cumyl peroxide, α,α′-bis(t-butylperoxy-m-isopropyl)benzene, α,α′-bis(t-butylperoxy)diisopropylbenzene, 2,5-dimethyl-2,5-di(t-butylperoxy)hexane, acetyl peroxide; isobutyryl peroxide, octanoyl peroxide, decanoyl peroxide, lauroyl peroxide, 3,5,5-trimethyl hexanoyl peroxide, benzoyl peroxide, 2,4-dichlorobenzoyl peroxide, m-toluoyl peroxide, t-butyl peroxyacetate, t-butyl peroxyisophtalate, t-butyl peroxy-2-ethylhexanoate, t-butyl peroxylaurate, t-butyl peroxybenzoate, di-t-butyl peroxyisophthalate, 2,5-dimethyl-2,5-di(benzoylperoxy)hexane, t-butyl peroxymaleic acid, t-butyl peroxyisopropylcarbonate, cumyl peroxyoctate, t-butyl hydroperoxides, cumene hydroperoxides, diisopropylbenzene hydroperoxides, 2,5-dimethylhexane-2,5-dihydroperoxide, and 1,1,3,3-tetramethylbutyl hydroperoxide. These peroxide curing agents can be used alone or in combination. The peroxide curing agent can be present in amount from about 0.01 wt. % to about 10 wt. %, specifically about 0.1 wt. % to about 5 wt. %, and more specifically about 0.2 wt. % to about 1 wt. %, based on the weight of silicone polymer 110. In a particular embodiment, silicone polymer 110 is vinyl terminated silicone polymer that is combined with methyl ethyl ketone peroxide and heated above 100° C. to form cross-linked silicone polymer 106, which is cross-linked vinyl modified PDMS.

In an embodiment, cross-linked silicone polymer 106 is made by subjecting silicone polymer 110 to hydrosilation. Here, cross-linked silicone polymer 106 is made by combining inorganic additive 108 with silicone polymer 110 and reacting: a first part that includes silicone polymer 110 that is the vinyl terminated silicone polymer and inorganic additive 108; and a second part that includes an organosilicon compound that includes silicon-bonded hydride groups that react with a the vinyl group of the vinyl terminated silicone polymer of the first part, wherein the reaction occurs in a presence of a catalyst such as a platinum group catalyst that is present in an amount effective to promote cross-linking silicone polymer 110 via the organosilicon compound.

The second part can include an organosilicon compound containing, a (e.g., 2 or 3) silicon-bonded hydride group, i.e., a hydrogen atom per molecule. The silicon-bonded hydride groups can be bonded to different silicon atoms. Remaining valences of silicon atoms in the organosilicon compound are satisfied by a divalent oxygen atom or monovalent radical such as an alkyl group having from 1 to 6 carbon atoms per radical, e.g., methyl, ethyl, propyl, isopropyl, butyl, tertiary butyl, pentyl, hexyl, cyclohexyl, substituted alkyl radical, aryl radical, substituted aryl radical., and the like. The silicon-bonded hydride group containing organosilicon compound can be a homopolymer, copolymer, or combination thereof that contains siloxane units such as RSiO_{1.5}, R₂SiO, R₃SiO_{0.5}, RHSiO, HSiO_{1.5}, R₂HSiO_{0.5}, H₂SiO, RH₂SiO_{0.5} and SiO, wherein R is the monovalent radical, e.g., as defined above. Examples include a polymethylhydrogensiloxane cyclic; copolymer of trimethylsiloxy and methylhydrogensiloxane; copolymer of dimethylhydrogensiloxy and methylhydrogensiloxane; copolymer of trimethylsiloxy, dimethylsiloxane and methylhydrogensiloxane; copolymer of dimethylhydrogensiloxane, dimethylsiloxane and methylhydrogensiloxane; and the like.

The catalyst included in the hydrosilation reaction can be the platinum group metal-containing catalyst that catalyzes, e.g., addition of silicon-bonded hydrogen atoms (hydride groups) to silicon-bonded vinyl radicals. The platinum group metal-containing catalyst can be a platinic chloride, salt of platinum, chloroplatinic acid, various complexes, and the like. The platinum group metal-containing catalyst can be present in a catalytic amount. In an embodiment, the platinum group metal-containing catalyst is chloroplatinic acid, preferably complexed with a siloxane such as tetramethylvinylcyclosiloxane (i.e. 1,3,5,7-tetramethyl-1,3,5,7-tetravinylcyclosiloxane).

In an embodiment, cross-linked silicone polymer 106 is made by subjecting silicone polymer 110 to condensation curing in which silicone polymer 110 (e.g., hydroxy terminated silicone polymer) is combined with inorganic additive 108 and a condensation catalyst (e.g., a metal soap catalyst such stannous octoate in a presence of moisture, a tin compound, and the like), and cross-linker such as tetraethyl ortho silicate, triacetoxy silane, a surface modifier (e.g., the titanate, zirconate, and the like), and the like. In an embodiment, the surface modifier is titanate in a presence of the tin compound or a metal-organic compound. Exemplary tin compounds include bis(2-ethylhexanoate)tin, bis(neodecanoate)tin, di-n-butylbis(2-ethylhexylmaleate)tin, di-n-butylbutoxychlorotin, di-n-butyldilauryltin, dioctyldilauryltin, titanium di-n-butoxide, titanium diisopropoxide, titanium trimethylsiloxide, and the like.

Coating composition 104 is applied by knife coating to substrate 102 at a temperature from 25° C. to 100° C. A solvent can be included in coating composition 104 before being applied to substrate 102 to provide a selected viscosity of coating composition 104. A solvent can be included in coating composition 104 in an amount up to a 100 weight percent (wt. %), specifically from 5 wt. % to 40 wt. %, based on a weight of coating composition 104. Exemplary solvents include a xylene, pentane, chloroform, ether, tetrahydrofuran, hexane, n-heptane, cyclohexane, dimethoxyethane, toluene, benzene, t-butyl alcohol, ethyl acetate, methanol, and the like. Cross-linking of silicone polymer 110 in coating composition 104 can be controlled by performing the cross-linking at a selected temperature or in a presence of a selected amount of a catalyst or inhibitor included in coating composition 104.

Exemplary inhibitors include 1,3-divinyltetramethyldisiloxane, 1,3,5,7-tetravinyl-1,3,5,7-tetramethylcyclotetrasiloxane, and the like. Curing can start before disposing coating composition 104 on substrate 102. A rate of curing reaction can be controlled thermally, e.g., the rate of curing silicon polymer 110 can be decreased by decreasing a temperature at which curing occurs. After disposing coating composition 104 on substrate 102, the temperature can be increased to completely cross-link silicone polymer 110. In a certain embodiment, silicone polymer 110 is vinyl modified PDMS (C═C/PDMS), and cross-linking includes hydrosilation in presence of a catalyst (e.g., Pt) in an addition reaction. According to an embodiment, silicone polymer 110 is hydroxy modified PDMS (OH/PDMS), and cross-linking includes performing a condensation reaction in which an alkoxy silane and a metal alkoxide catalyst (e.g., a tin-based catalyst) are present to produce an alcohol as a by-product in an absence of catalyst poisoning.

In an embodiment, silicone polymer 110 is prepared from vinyl modified PDMS (e.g., sold under the trademark SYLGARD 184 and commercially available from Dow Corning) and a hydroxy modified PDMS (e.g., sold under the trademark MOLD MAX 10 SMOOTH-ON and commercially available from Smooth-On, Inc.). Here, the vinyl modified PDMS is a two-component silicone rubber containing about 20 wt % nanosilica. Also, the hydroxy modified PMDS can be a two-component silicone rubber. The process also includes cross-linking the vinyl modified PDMS or the hydroxy modified PDMS to form cross-linked silicone polymer 106.

It is contemplated that coating composition 104 is a fluid (e.g., paste, liquid, and the like) or dry composition (e.g., powder, pellet, film, and the like). Disposing coating composition 104 on substrate 102 can include fluid disposition of coating composition 104 on substrate 102 or dry disposition of coating composition 104 on substrate 102. Fluid disposition can include knife coating (e.g., using a wire wound bar, round bar, and the like), roll coating, dip coating, impregnating (e.g., dipping substrate 102 into coating composition 104 and removing an excess of coating composition 104 from substrate 102 by squeeze rolling or doctor blading), spray coating (spraying coating composition 104 on a web or roll and transferring coating composition 104 form the web or roll to substrate 102), and the like. Dry disposition can include calendaring, laminating, melt coating, and the like.

In an embodiment, disposing coating composition 104 on substrate 102 includes knife coating of coating composition 104 onto substrate 102 at room temperature. A thickness of coating composition on substrate can be adjusted to provide a final weight uptake of coating composition 104.

According to an embodiment, the process for making fire and smoldering resistant article 100 also includes curing the fire and smoldering resistant article at a temperature from 10° C. to 200° C., specifically from 80° C. to 180° C., and more specifically from 100° C. to 130° C. for a time effective to cure coating composition 104. Curing can be performed for a time less than 24 hours, specifically from 60 seconds to 10 hours, and more specifically from 10 minutes to 120 minutes.

In an embodiment, reinforcing member 150 is present and disposed on substrate 100 to, and making article 100 includes compressing coating composition 104 to disposed coating composition 104 into interstitial gap 152 of reinforcing member 150.

Fire and smoldering resistant article 100 has beneficial and advantageous properties. According to an embodiment, silicone polymer 110 has a viscosity from about 500 centipoise (cps) to about 100,000 cps at 25° C, before cross-linking. After cross-linking cross-linked silicone polymer 106 has a viscosity from about 500 centipoise (cps) to about 100,000 cps at 25° C., After curing, cross-linked silicone polymer 106 has a viscosity from about 500 centipoise (cps) to about 100,000 cps at 25° C.

Coating composition 104 advantageously maintains a rigidity of substrate 104 such that a rigidity of article 100 is substantially identical to the rigidity of substrate 104 without coating composition 104 disposed thereon. It is contemplated that a rigidity of article 100 can be greater than that of substrate 102 without coating composition 104.

A flexibility of cross-linked silicone polymer 106 can be selected by an amount of cross-linking present in cross-linked silicone polymer 106. Further, the amount of cross-linking can be controlled by a number or type of functional groups present that are available to be cross-linked in silicone polymer 110 (e.g., PDMS, hydroxyl modified PDMS, vinyl modified PDMS, or a combination thereof).

Fire and smoldering resistant article 100 can include a substrate 102 that is fabric that is 450 g/m², wherein a smoldering resistance of fire and smoldering resistant article 100 meets a pass criterion for Section 1 of Technical Bulletin 117-2013, “Requirements, Test Procedure and Apparatus for Testing the Smolder Resistance of Materials Used in Upholstered Furniture”, State of California Department of Consumer Affairs (June 2013). Beneficially, a fire resistance of article 100 is greater than substrate 100 in an absence of coating composition 104 disposed thereon.

Fire and smoldering resistant article 100 and processes herein have numerous advantages and benefits. Fire and smoldering resistant article 100 is durable, resistant to smoldering or flaming ignition and provides a fire-blocking barrier and prevents flame penetration. In an embodiment, fire and smoldering resistant article 100 does not include a halogenated flame retardant, or formaldehyde, or a combination thereof. Also the coating is flexible and does not significantly affect the feel and touch of the fabric. Further, cross-linked silicone polymer 106 and silicone polymer 110 decomposes to produce inorganic silica in response to being subjected to a stimulus such as heat, e.g., a temperature effective to burn wood. Without wishing to be bound by theory, it is believed that the inorganic silica does not smolder and is resistant to smoldering and open flame.

In an embodiment, coating composition 104 suppresses smoldering and flammability of substrate 102, e.g., a cover fabric. The cover fabric can be, e.g., a cover fabric disposed on an item such as upholstered furniture. Coating composition 104 is disposed on a back side of the cover fabric to form a backcoating in a backcoated article. Coating composition does not substantially affect face fibers of the cover fabric in a property such as color, hand, or visual appearance. The cover fabric retains its flexibility after disposal of coating composition thereon such that the backcoating is as flexible as the cover fabric without coating composition 104.

In an embodiment, coating composition 104 includes inorganic additive 108, e.g., unmodified inorganic additive 114, modified inorganic additive 116, or a combination thereof. Advantageously, inorganic additive 108 can be non-toxic. Further, coating composition 104 is durable and resistant to decomposition or deterioration, and coating composition 104 or backcoating made therefrom can be subjected to laundering without decomposition or deterioration. Coating composition 104 of backcoated article 100 provides a selected resistance to smoldering and open flame. According to an embodiment, coating composition 104 is a layer disposed on the cover fabric. In some embodiments, coating composition 104 can include a plurality of layers. It is contemplated that a coating that includes the single layer is advantageous as compared to a plurality of layers of cover fabric or barrier material present in some upholstered furniture that is commercially available today with respect to achieving resistance to smoldering and open flame.

The articles and processes herein are illustrated further by the following Examples, which are non-limiting.

### EXAMPLES

### Example 1

### Coating Compositions

A first coating composition was prepared by combining 65 wt % ATH (based on a total weight of the coating composition) with vinyl modified PDMS (commercially available under the tradename SYLGARD 184) and mixing with a bladeless mixer to form a first paste having a viscosity effective to spread the composition on the substrate. A second coating composition was prepared by combining 65 wt % VS/ATH (based on a total weight of the coating composition) with vinyl modified PDMS (commercially available under the tradename SYLGARD 184) and mixing with the bladeless mixer to form a paste having a viscosity effective to form a first paste having a viscosity effective to spread the composition on the substrate.

### Example 2

### Properties of Coating Compositions

A portion of the first composition and a portion of the second composition according to Example 1 were cured in an oven for 2 hours at 100° C. After curing, the second composition that included VS/ATH was more flexible and softer than the first composition that included ATH. A total heat released by the first composition and the second composition was from 3 kiloJoules per gram (kJ/g) to 4 kJ/g.

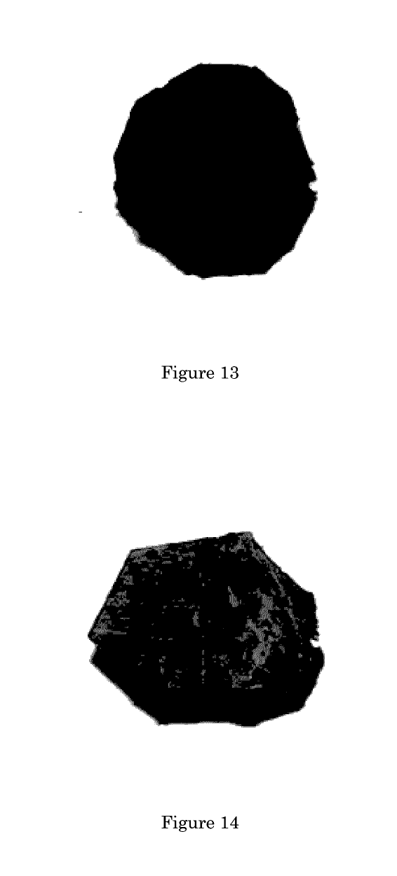

Thereafter, the first and second compositions were heated to 1000° C. under a nitrogen atmosphere and then cooled to room temperature. After cooling, the second composition (including VS/ATH) had a color that was darker than a color of the first composition (including ATH) because the second composition included more carbon than the first composition. FIG. 13 shows a photograph of the cured second composition produced at 1000° C. under nitrogen and that included 65 wt % of VS/ATH in vinyl modified PDMS. FIG. 14 shows a photograph of the cured first composition produced at 1000° C. under nitrogen and that included 65 wt % of ATH in vinyl modified PDMS.

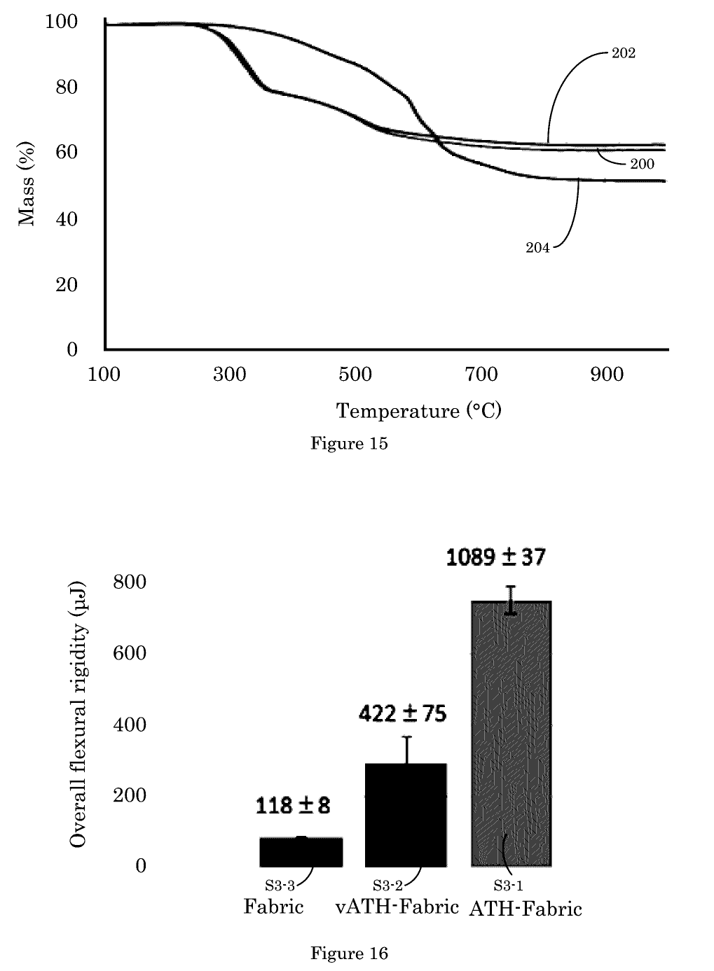

FIG. 15 shows a graph of mass % (based on a total weight of a sample at 100° C.) versus temperature for the first coating composition 200 (ATH disposed in vinyl modified PDMS) and second coating composition 202 (VS/ATH disposed in vinyl modified PDMS), and substrate 204 (with vinyl modified PDMS). Here, ATH and VS/ATH thermally stabilized vinyl modified PDMS. As a result, first coating composition 200 and second coating composition 202 had less mass loss percentage than the substrate fabric that only had the vinyl modified PDMS.

### Example 3

### Flexural Rigidity of Coating Composition on Fabric

A fabric (blue denim) with an area density of 450 g/m² was cut into four pieces that were 25 mm by 200 mm. A first sample (S3-1) was prepared by applying the first coating composition from Example 1 to a back surface of a piece of fabric with a spatula. A second sample (S3-2) was prepared by applying the second coating composition from Example 1 to a back surface of another piece of fabric with a spatula. A third sample (S3-3) was another piece of fabric without disposition of any coating composition.

Each sample was cured in an oven for 2 hours at 100° C. The mass of the coating is equal to the mass of the fabric. The flexural rigidity of the fabrics was measured by Peirce's cantilever test, which is described in Lammens et al, Textile Research Journal 84, 1307 (2014), which is incorporated by reference in its entirety herein.]. Four independent measurements of flexural rigidity were carried out for each fabric: in the machine direction face up/down (4 samples), and in the cross-machine direction face up/down (4 samples). The overall fabric flexural rigidity was calculated as the geometric mean of these four values.

FIG. 16 shows a graph of overall flexural rigidity for S3-1, S3-2, and S3-3. The overall flexural rigidity of the coated fabric was 1089+/−37 microJoules (μJ) for S3-1 and 422+/−75 μJ for S3-2. Here, the flexibility for S3-2 was greater than twice that of S3-1. It should be noted that surface modifier in the second coating composition did not change thermal stability (see FIG. 15) or a total heat release.

### Example 4

### Fire Resistance of Backcoated Articles

The paste of the second coating composition from Example 1 was disposed on a back of a cover fabric with a spatula. The cover fabric was a cellulosic fabric that had an aerial density of 445 grams per square meter (g/m²). A mass of the second coating composition and cover fabric was double a mass of the (uncoated) cover fabric. The coated fabric was cured in an oven for 2 hours at 80° C. to form a backcoated article.

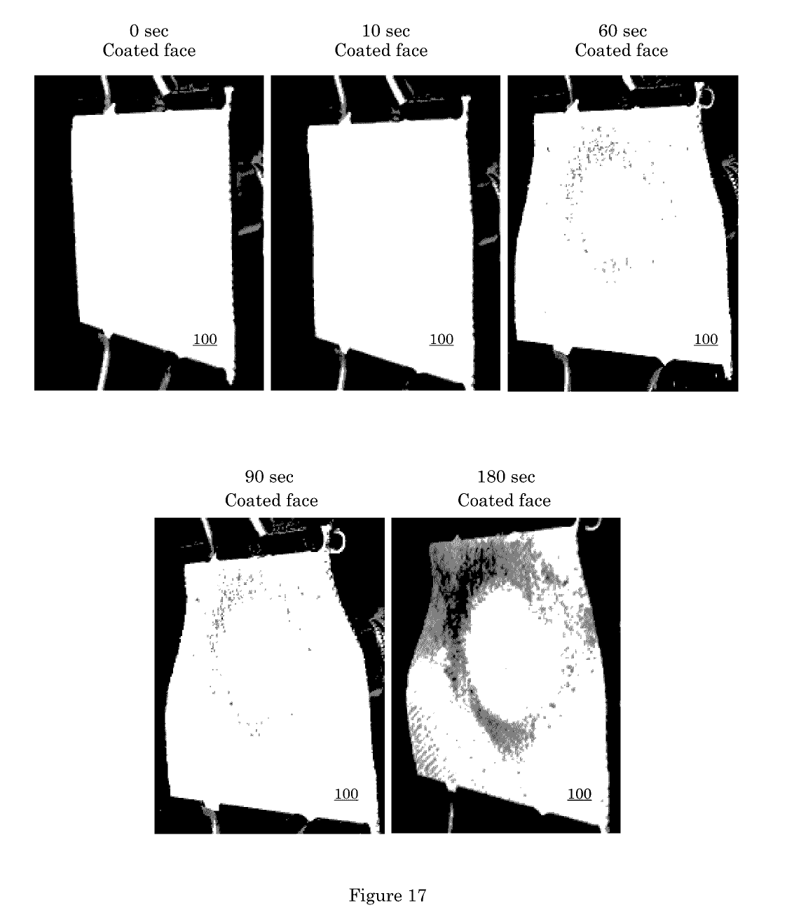

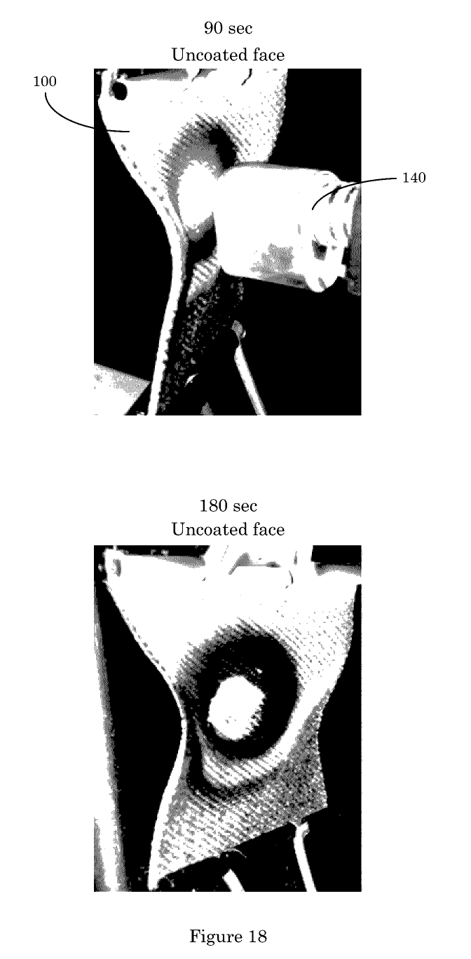

To determine a fire resistance of the backcoated article 100, the backcoated article was subjected to a flame from fire torch 140 (butane torch commercially available as Bernzomatic Model ST2200). Photographs from time-lapse photography of a back surface (i.e., the coated surface) of backcoated article 100 are shown in FIG. 17 for 0 seconds (no flame), 10 seconds (flame still applied in photograph), 60 seconds, 90 seconds, and 180 seconds. Note that the flame was still applied in photograph for 10 seconds, 60 seconds, 90 seconds, and 180 seconds. Similarly, FIG. 18 shows time-lapse photographs of a front surface (opposed the coated back surface and was uncoated) of backcoated article 100 subjected to the flame for 90 seconds and 180 seconds.

An area of fabric directly exposed to flame torch 140 did not spread the flame over backcoated article 100. The flame penetrated backcoated article 100 after about 2 minutes from ignition of the torch due to a small crack in the fabric, but the rest of the fabric without the crack was still intact. Also, the cellulosic fabric passed a standard flammability test (Mydrin test) only when backcoated with the coating composition.

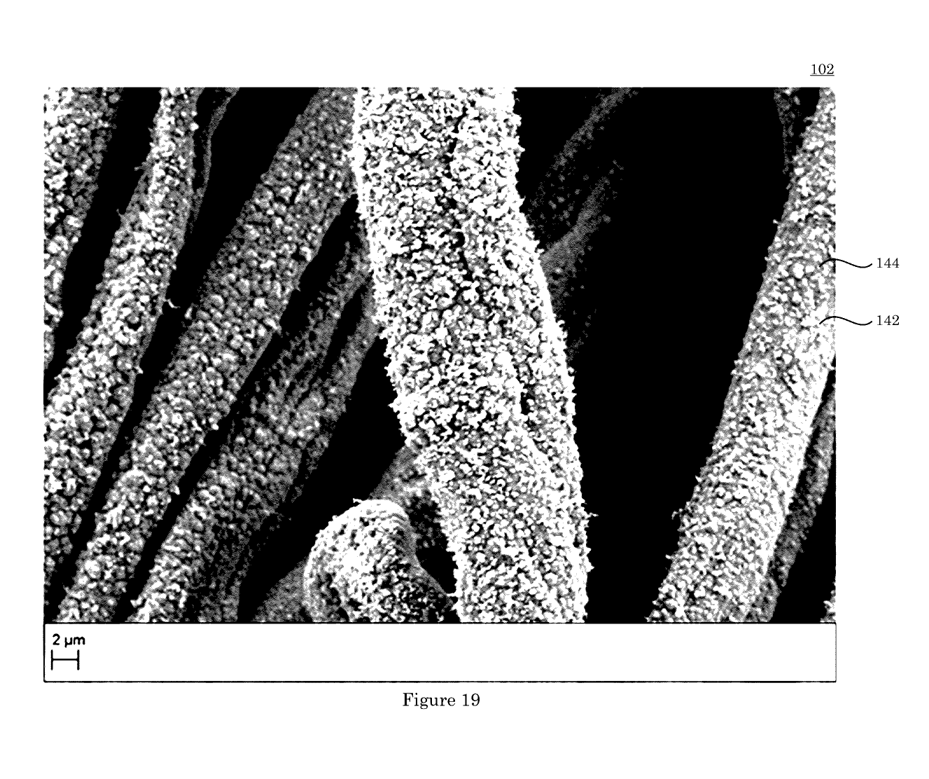

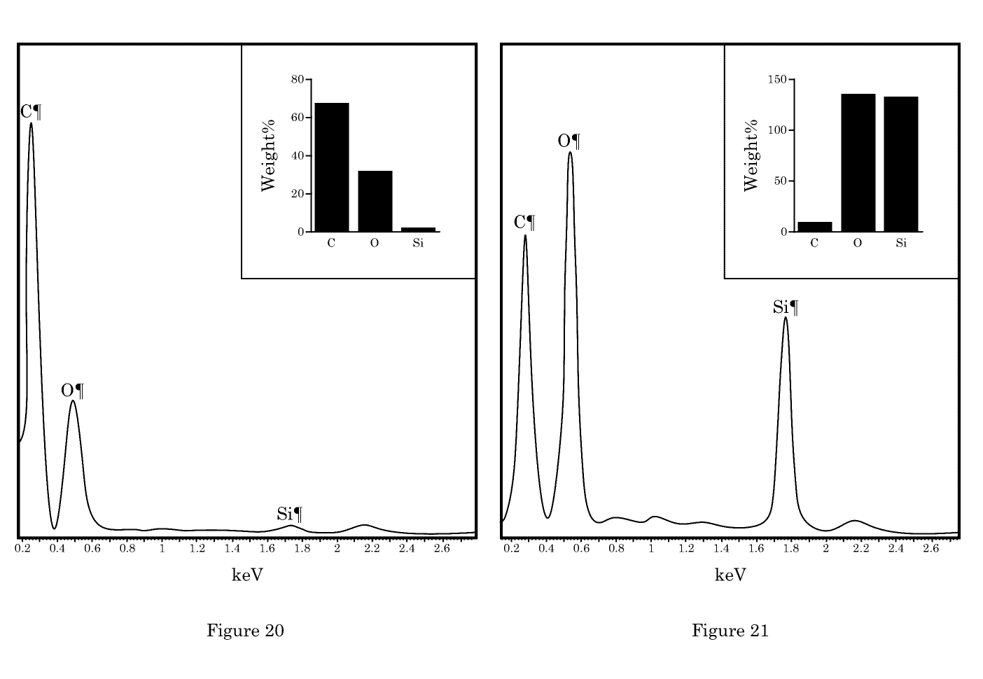

A scanning electron microscope (SEM) micrograph of the backcoated article after being subjected to flame torch 140 is shown in FIG. 19. Elemental analysis from the SEM micrograph is shown in FIG. 20 and FIG. 21. Without wishing to be bound by theory, it is believed that the cross-linked silicone polymer (vinyl modified PDMS) in the coating composition released monomers that wetted the cellulosic fibers of the cover fabric and migrated to the front face (side of the cover fabric opposite to the coating) of the cover fabric from the back face (coated surface) of the cover fabric. The monomers were oxidized to form a silica coating on the surface of strands of the cellulosic fabric, which appeared as white particles on the strands as shown in the micrograph shown in FIG. 19. That is, silica formed on the front face after being subjected to flame torch 104. Silicone monomers generated during thermal degradation of the vinyl modified PDMS wicked through the cellulosic fabric and formed ceramic particles as a fire barrier on a surface of the exposed cellulose. This barrier protected the fabric from oxidation due to open flame or smoldering.

FIG. 20 and FIG. 21 show a relative amount of carbon (C), oxygen (O), and silicon (Si) as determined by scanning electron microscopy/energy-dispersive X-ray spectroscopy (SEM/EDX) on the front face of backcoated article 100 before being subjected to combustion conditions (FIG. 20) and after being subjected to combustion conditions (FIG. 21). An amount of Si increased from after combustion due to silica formation during heating the coating composition disposed on the cover fabric.

### Example 5

### Comparative Fire Resistance of Uncoated Fabric

The cover fabric (cellulosic fabric with the aerial density of 445 grams per square meter (g/m²)) was also used here except no coating composition was disposed on the fabric.

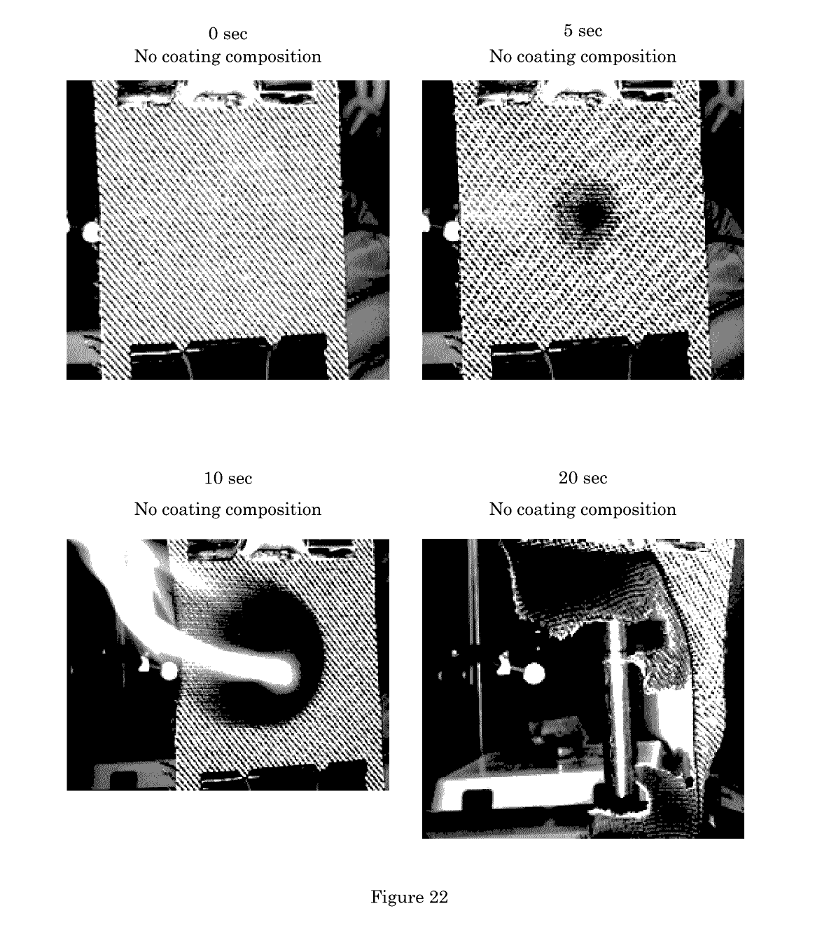

A fire resistance of the uncoated fabric was tested with the fire torch, and time-lapse photographs are shown in FIG. 22. For the uncoated fabric, the flame burned through the uncoated fabric in less than 10 seconds, and charring occurred by 5 seconds. Flame spread over the entire uncoated fabric.

### Example 6

### Smoldering Resistance of Coated Article

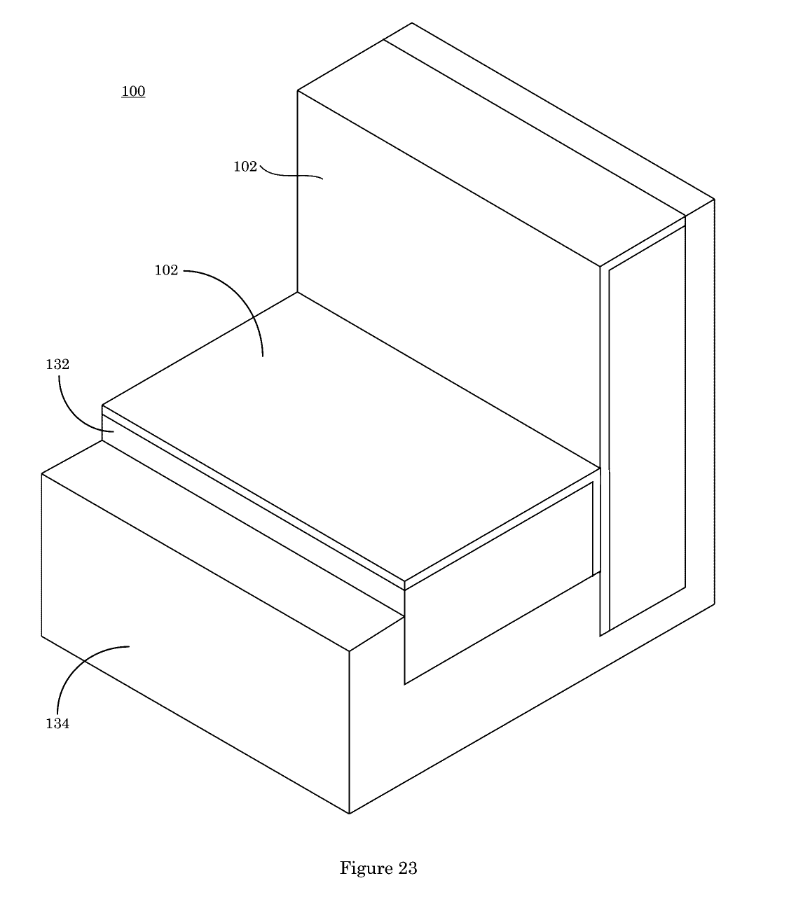

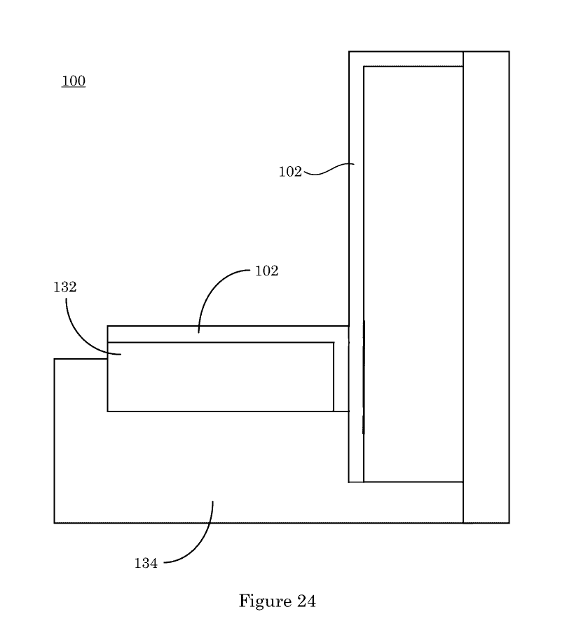

Smoldering resistance of the second coating composition from Example 1 was determined using a mockup structure from California Technical Bulletin 117, referenced in 73 CFR 11702 (entitled Standard for the Flammability of Residential Upholstered Furniture). With reference to FIG. 23 (a perspective view of the mockup) and FIG. 24 (a side view of the mockup), foam 132 (standard Cal 117-2013) that included was covered by cellulosic fabric 102 with an area density of 450 g/m². Foam 132 was disposed on support frame 134. Foam 132 had a high smoldering propensity.

Before fabric 102 was disposed on foam 132, the paste of the second coating composition from Example 1 was disposed on a back face of fabric 102, and fabric 102 with the second coating composition was heated at 100° C. for 240 minutes to cure the second coating composition. Thereafter, fabric 100 to with the cured second coating composition was disposed on foam 132.

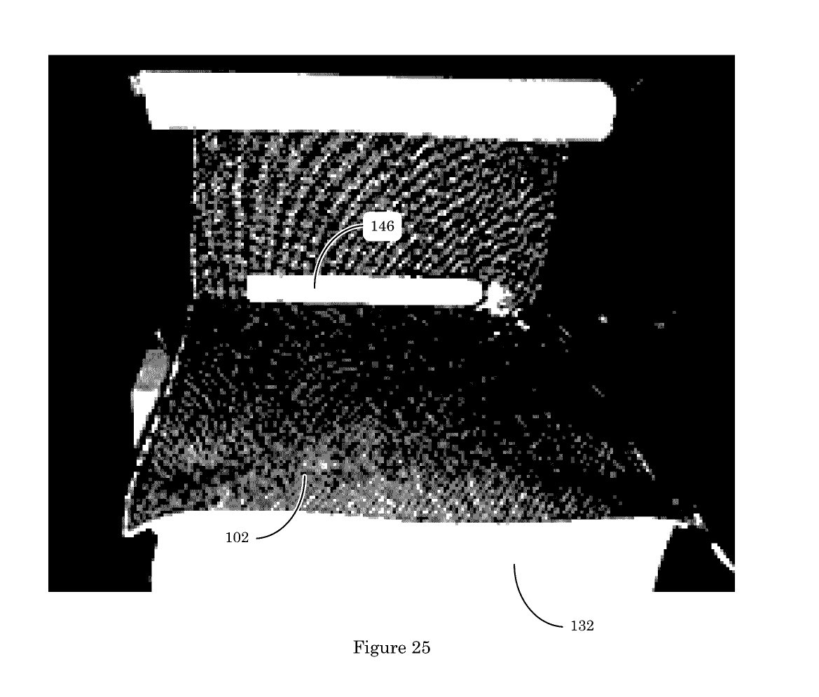

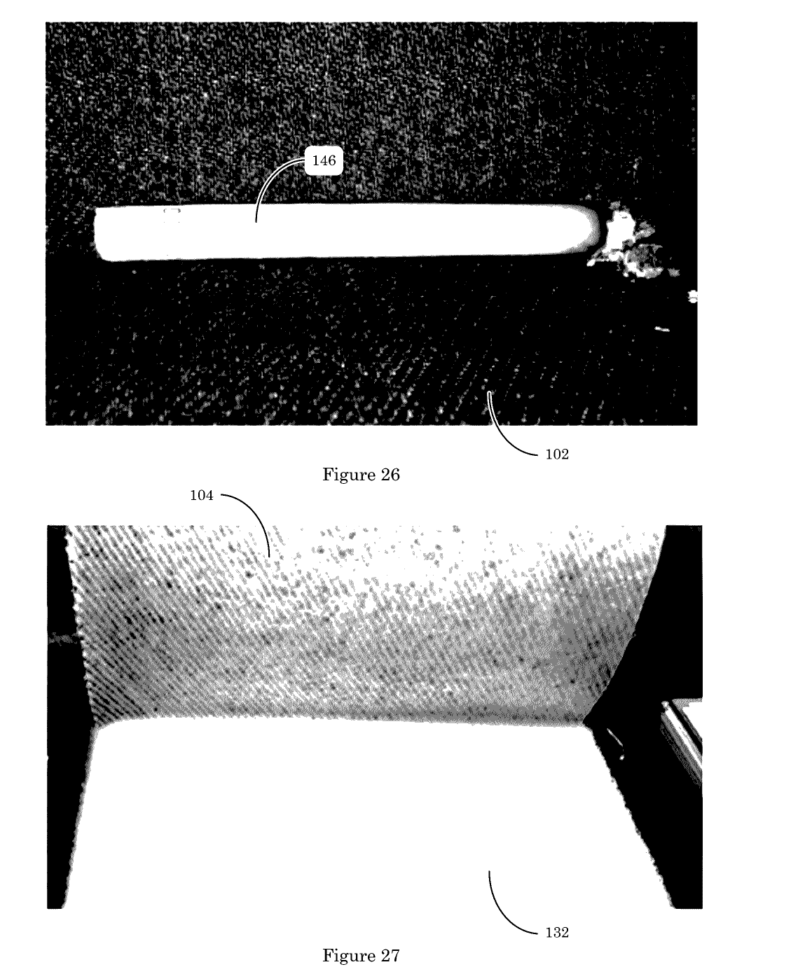

Standard reference cigarette 146 (available from the National Institute of Standards and Technology (NIST) as NIST SRM 1196) was disposed on a front of fabric 102 and lit on fire as an ignition source. Surprisingly, cigarette 146 self-extinguished in less than a minute. FIG. 25 shows a photograph of self-extinguished cigarette 146 on fabric 102, and FIG. 26 shows an enlarged view of cigarette 146 on fabric 102.

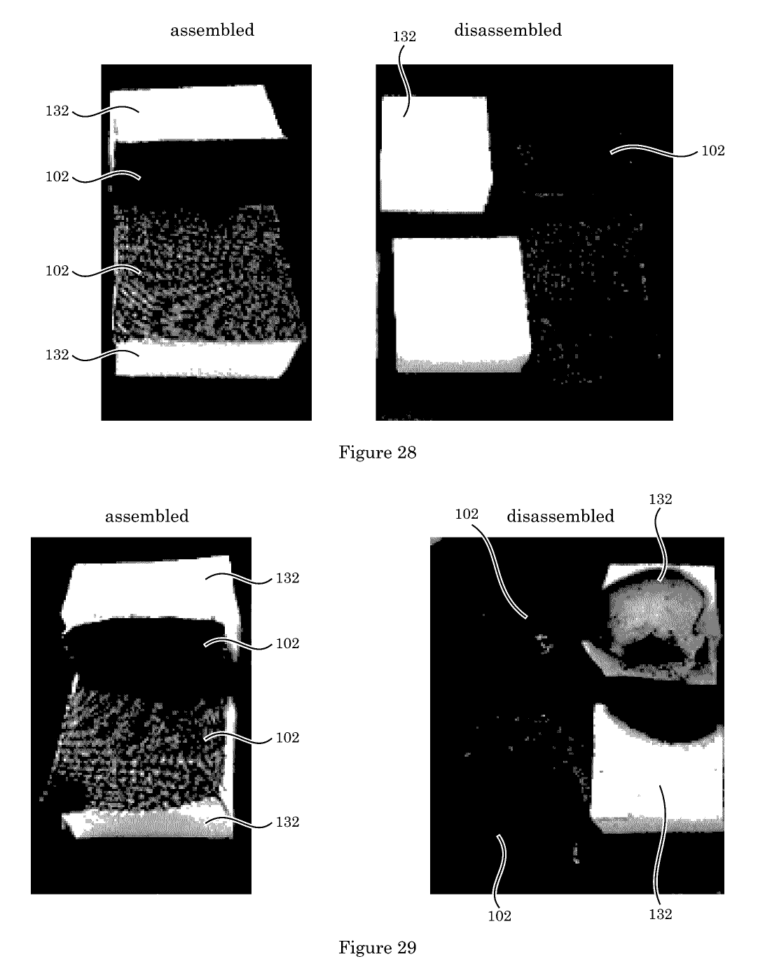

No smoldering was observed for fabric 102 or for foam 132 when fabric 102 was coated with the second coating composition. FIG. 27 shows photographs of second coating composition 104 disposed on a back face of fabric 102 when pulled away from foam 132. Here, foam 132 and coating composition 104 showed no decomposition or charring due to ignition of cigarette 146. Additionally, FIG. 28 shows a top perspective view of fabric 102 disposed on foam 132 as assembled (right-hand photograph) and disassembled (left hand photograph) after cigarette 146 was self-extinguished on substrate 102. Again, foam 132 and fabric 102 do not decompose or char.

### Example 7

### Smoldering Resistance of Uncoated Article

A second mockup structure identical to the mockup structure described in Example 6 was constructed, wherein fabric 102 was disposed on foam 132 except no coating composition was present on fabric 102.

Standard reference cigarette 146 (available from the National Institute of Standards and Technology (NIST) as NIST SRM 1196) was disposed on a front of fabric 102 and lit on fire as an ignition source. Cigarette 146 did not self-extinguished but was extinguished with water after 30 min. Here, the mockup with uncoated fabric 102 showed intense, sustained smoldering.

FIG. 29 shows a top perspective view of fabric 102 disposed on foam 132 as assembled (right-hand photograph) and disassembled (left-hand photograph) after cigarette 146 was extinguished with water on substrate 102. Foam 132 and fabric 102 decomposed and charred as a result of the 30-minute test.

### Example 8

### Backcoating Including Silicone Elastomer and Vinyl Modified Aluminum Hydroxide

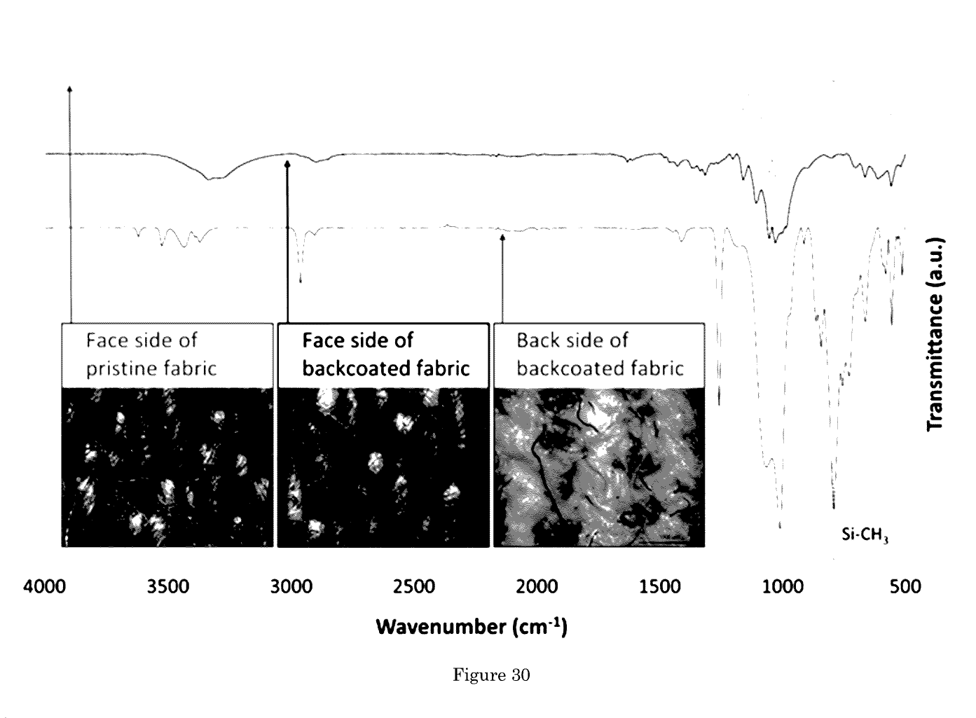

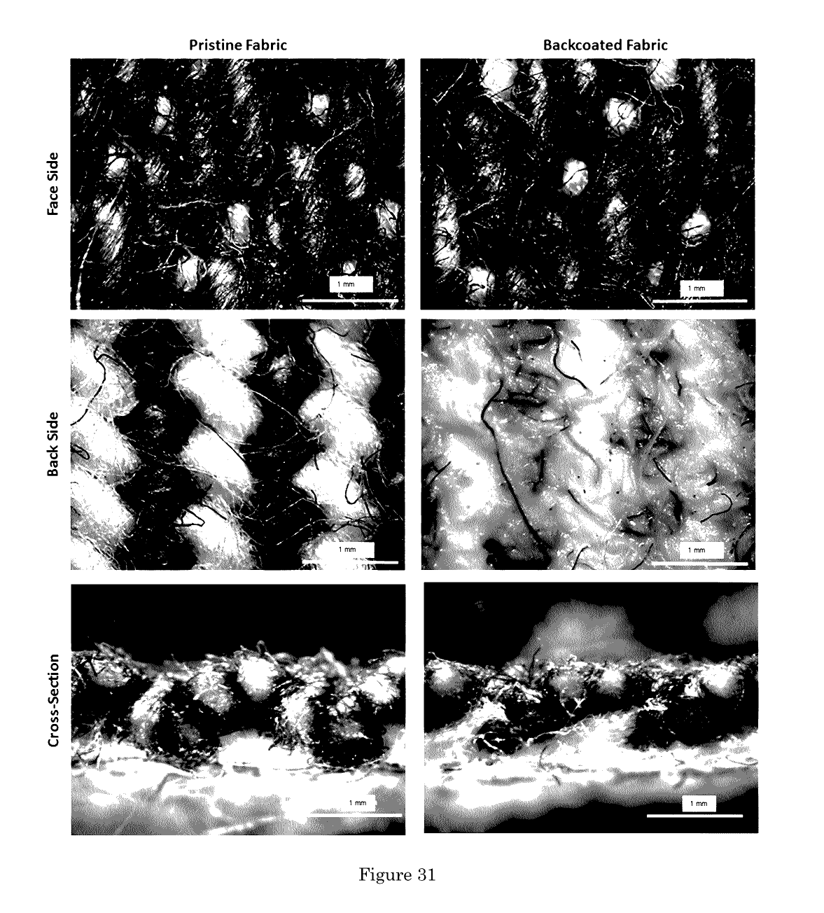

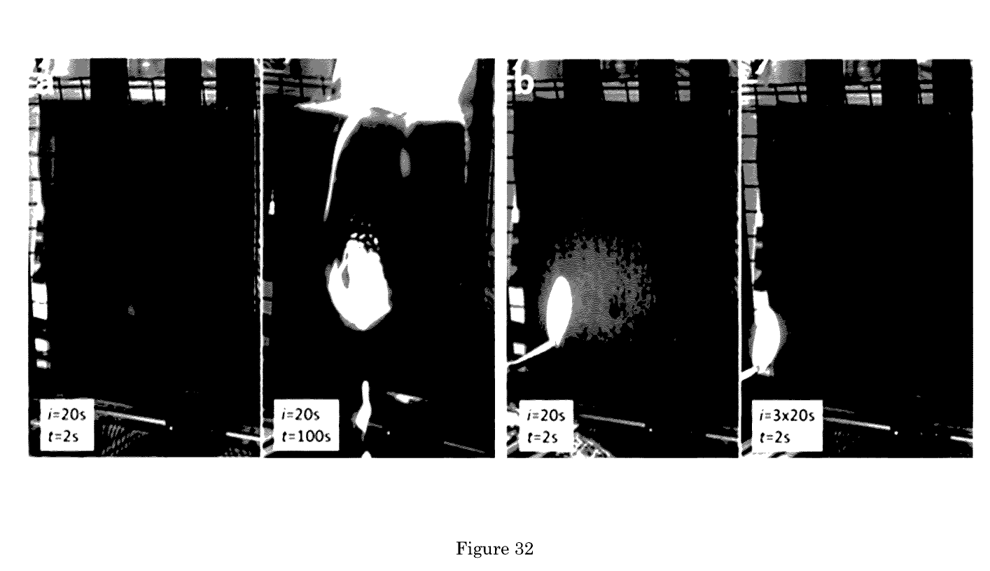

A coating composition was prepared that included a silicone elastomer (crosslinked by Pt-catalyzed hydrosilation) as a binder; and a vinyl-modified aluminum-hydroxide and nanosilica as a flame-retardant. The coating composition was disposed on a substrate as a backcoating. The substrate was a smoldering prone and flammable cotton fabric that had an area density of about 448 g/m². The backcoating was wash resistant (no significant mass loss after 40 C water soak) and durable (chemical resistance, UV resistance, and temperature resistance and adhesion strength). The backcoating was disposed on a back side of the substrate by knife coating and did not affect a color or appearance of the fabric's face. FIG. 30 shows Fourier transform infrared spectroscopy (FTIR) spectra for the substrate without the backcoating (“pristine fabric”), face side of substrate (backcoating on disposed on opposite face), and back side of substrate with backcoating disposed thereon. FTIR data were translated vertically for clarity. The photographs show optical micrographs of the samples (bar size 1 mm). As shown in the FTIR spectra, silicone was not visible on the face of the backcoated substrate but was detected at 790 cm⁻¹ (Si—CH₃ stretching mode) and might have been due to inter-yarn gaps in the substrate. FIG. 31 shows additional photographs of the uncoated substrate (“pristine fabric”) and backcoated substrate.

After coating, the substrate showed a negligible increase in thickness (see FIG. 31) but almost a 2-fold increase in area density due to the high content of high-density fillers (aluminum hydroxide and silica represent approximately 78% of the mass of the coating). The binder penetrated and filled gaps between the cotton fibers of the substrate. Table 1 lists overall flexural rigidity and area density of the substrate.

TABLE 1

| | | | Overall flexural |
|---|---|---|---|
| | Backcoating | Area density | rigidity |
| Sample | formulation | [g m⁻²] | [μJ] |
| Fabric | no backcoating | 448 ± 3 | 82 ± 6 |
| ATH-Fabric | aluminum hydroxide | 900 ± 25 | 751 ± 26 |
| vATH-Fabric | vinylsilane-modified | 879 ± 10 | 291 ± 52 |
| | aluminum hydroxide | | |

Here, the backcoating that included vinyl-modified aluminum-hydroxide (vATH) improved a drape and comfort of the backcoated substrate and decreased the overall flexural rigidity stiffness by a factor of 2.6 as compared to just coating the substrate with an aluminum-hydroxide formulation (ATH). The overall flexural rigidity was about 80 μJ for the pristine fabric (Fabric), about 750 μJ for the backcoated fabric with aluminum-hydroxide (ATH-Fabric) and about 290 μJ for backcoated fabric with vinyl-modified aluminum-hydroxide (vATH-Fabric). The flexural rigidity measured for a commercial halogen-free fire barrier for (RUF) was about 840 μJ.

The surface modifier reduced the stiffness of the backcoating without reducing a char yield and flame retardancy due to including excess vinyl groups. These vinyl groups were not consumed by hydrosilylation but were available to crosslink at fire temperatures. Table 2 lists microscale combustion calorimetry data for the composition with aluminum hydroxide (ATH) and for the backcoating composition with vinylsilane-functionalized aluminum hydroxide (vATH) and included total heat released (THR), peak of heat release rate (PHRR), and temperature at which the PHRR occurs (TPHRR).

TABLE 2

| | Residue | THR | PHRR | TPHRR |
|---|---|---|---|---|
| Sample | [%] | [kJ g−1] | [W g−1] | [° C.] |
| noATH | 0.4 ± 0.1 | 13.9 ± 1.7 | 70.7 ± 5.8 | 602 ± 17 |
| ATH | 71.9 ± 0.6 | 3.83 ± 0.06 | 17.0 ± 1.1 | 530 ± 2 |
| vATH | 72.2 ± 0.9 | 3.80 ± 0.20 | 17.3 ± 0.6 | 528 ± 3 |

Here, a reduction of about 75% for THR and PHRR was produced by vATH as compared to the formulation without aluminum hydroxide (noATH).

Smoldering resistance of the backcoated fabric was investigated according to ASTM E1353-08a with a mockup assembly of fabric and foam that mimicked a crevice between a seat and back cushions of actual RUF. The pristine cotton fabric substrate was smoldering prone and failed the test (sample smoldered after 45-minute test duration). The backcoated fabric (vATH-Fabric) did not smolder, suppressed charring in the foam substrate, and extinguished the cigarette used as an ignition source in less than 30 seconds.

The effect of the backcoating on the flammability performance of the fabric in upholstered furnishings was assessed by a simulated flame ignition version of the British standard BS5852. A piece of fabric (220 mm×150 mm) was pinned onto a flexible polyurethane foam (220 mm×150 mm×22 mm) to form a mockup back of RUF. A premixed butane gas burner with a flame height adjusted to 40 mm as specified in BS 5438 was used as an ignition source. The flame was applied to the face of the composite for 20 s and then removed. If the composite continued to flame or smoke for more than 2 mins or heat or afterglow for more than 15 min after removal of the ignition source, a “fail” was a result of the test. Otherwise, a “pass” was the result of the test. This bench-scale test provided an ignition behavior of full-scale products when tested in accordance with BS5852. The mockup with pristine fabric showed ignition after a first application of the ignition flame, rapid flame propagation, flaming dripping as shown in FIG. 32 (see panel a of FIG. 32). The mockup with vATH-Fabric passed the test because it did not ignite after the application of the ignition flame for 20 s, and ignition was not observed even after multiple applications of the ignition flame (3 flame applications of 20 s each) as show in panel b of FIG. 32. FIG. 32 shows photographs for this test that include photographs of the pristine fabric mockup (panels a) and the backcoated fabric (vATH-Fabric) mockup (panels b) during the flame ignition test. Text of insets indicate the time t after removal of the ignition flame at which the photographs were recorded and the flame impingement duration i of the ignition flame.

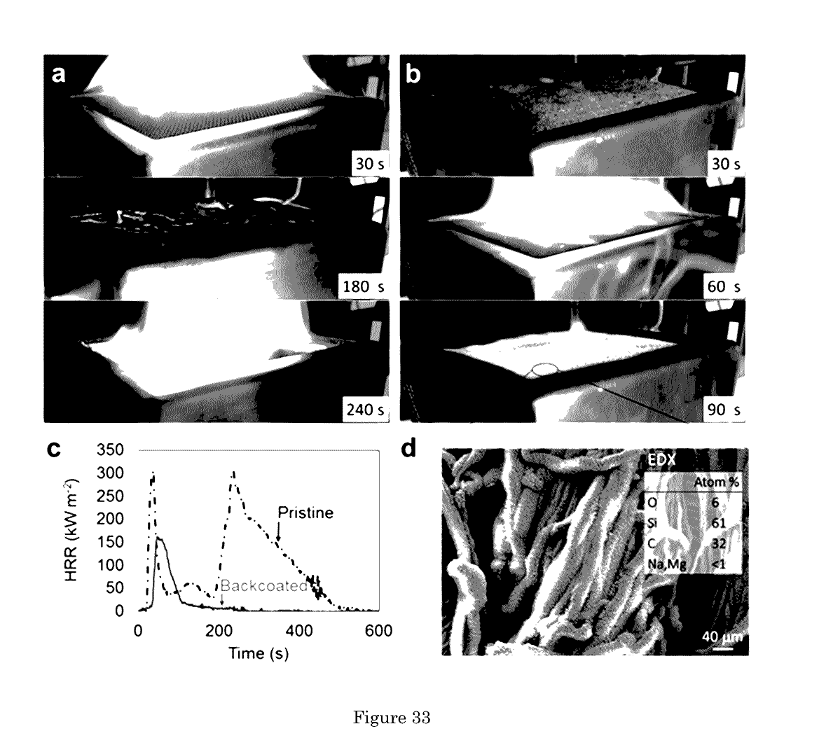

Cone calorimetry was performed according to ASTM E 1354 to investigate an effect of the backcoating on heat release rate of a fabric/foam mockup in a forced combustion scenario with an external heat flux of 35 kW/m2. The fabric substrate (94 mm by 94 mm) was placed onto foam (105 mm by 105 mm by 51 mm) and mounted on a retainer frame. The frame held the fabric in place and compressed down the foam by about 4 mm to induce tension in the fabric. In the pristine fabric mockup, the fabric ignited after 20 seconds and formed a char layer in the underlying foam as show in panel a of FIG. 33. After 180 seconds, flaming stopped and smoldering started, which caused oxidation and disrupted the char barrier. At this stage, a rate of pyrolysis of the foam increased, and the foam was exposed to an external heat flux from the cone heater. After 240 seconds, smoldering piloted the ignition of the pyrolyzing foam, which was now largely exposed. In the backcoated fabric mockup, the fabric ignited after 30 seconds and fully charred after 60 seconds. The fabric turned from a char black color to white and finally flame-out occurred after 90 seconds as shown in panel b of FIG. 33. Panel c of FIG. 33 shows a graph of heat release rate (HRR) versus time for the two mockups. For the pristine fabric mockup (pristine), the first peak in HRR was associated with combustion of the fabric, and the second broad peak was associated with fabric smoldering. The third peal was associated with combustion of the foam. For the backcoated fabric mockup (backcoated), a single peak was present due to ignition of the fabric. A ceramic protective coating generated on the surface of the charred fabric. The formation of a silica/silicon oxycarbide residue was consistent with energy-dispersive X-ray spectroscopy (EDX) data from the face-side of the fabric shown in panel d of FIG. 33. Surprisingly, the ceramic residue was generated ex-situ on the uncoated fabric side. Volatiles produced by decomposition of silicone were communicated through the fabric before generating a conformal coating that fully was embedded in the cotton fibers and shielded the fibers from heat and oxidation. A micrograph from scanning electron microscopy (SEM) of the fiber shape and structure (which were well preserved) is shown in panel d of FIG. 33. The production of the ceramic enhanced smoldering and flaming combustion of the fabric. Table 3 lists cone calorimetry data for ignition time, peak of heat release rate (PHRR), total heat release rate (THR), and foam residue. The backcoating increased ignition time by 55% and reduced PHRR by 48%, THR by 85%, and mass loss of the foam (main fuel source in RUF) by 94%. The backcoating inhibited fabric combustion due to smoldering or flaming and prevented ignition of the substrate.

TABLE 3

| | Ignition time | PHRR | THR | Foam Residue |
|---|---|---|---|---|
| Sample | (s) | (kW/m²) | (kJ/g) | [%] |
| Pristine | 20 ± 1 | 348 ± 39 | 53 ± 1 | 5.0 ± 0.3 |
| Backcoated | 31 ± 2 | 180 ± 18 | 8 ± 1 | 89 ± 1.1 |

The backcoating composition that included the inorganic additive in the silicone provided a durability of the coating and was halogen-free and formaldehyde-free. The flexibility of the backcoating (which provided drape and comfort to the backcoated substrate) was enhanced by vinylsilane modification of aluminum hydroxide without affecting flammability (as proved by microscale combustion calorimetry). The backcoating provide an unexpected combination of flaming and smoldering resistance without affecting color or general appearance of the face of the fabric. The requirements of the simulated flame ignition test and smoldering tests for upholstered furnishings were satisfied by the backcoating composition. From cone calorimetry, the backcoated fabric showed a reduction of 48% in the peak heat release and 85% in the total heat release as compared to the pristine fabric. When exposed to an intense heat source, the ceramic conformal coating was generated ex-situ on the face side of the fabric. As a result, flame penetration and the ignition of the foam (main fuel source in upholstered furnishing) were prevented.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A fire and smoldering resistant article comprising:
a substrate; and
a coating composition disposed on the substrate and comprising:
a cross-linked silicone polymer; and
an inorganic additive disposed among the cross-linked silicone polymer.

2. The fire and smoldering resistant article of claim 1, wherein the article further comprises a reinforcing member interposed between the substrate and the coating composition.

3. The fire and smoldering resistant article of claim 1, wherein the substrate comprises a fabric.

4. The fire and smoldering resistant article of claim 3, wherein the cross-linked silicone polymer comprises:
a reaction product of cross-linking polydimethylsiloxane (PDMS);
a reaction product of cross-linking a hydroxy modified PDMS;
a reaction product of cross-linking a vinyl modified PDMS; or
a combination comprising at least one of the foregoing reaction products.

5. The fire and smoldering resistant article of claim 4, wherein the cross-linked silicone polymer is the reaction product of cross-linking PDMS and comprises cross-linked PDMS.

6. The fire and smoldering resistant article of claim 4, wherein the cross-linked silicone polymer is the reaction product of cross-linking the hydroxy modified PDMS and comprises cross-linked hydroxy modified PDMS.

7. The fire and smoldering resistant article of claim 4, wherein the cross-linked silicone polymer is the reaction product of cross-linking the vinyl modified PDMS and comprises cross-linked vinyl modified PDMS.

8. The fire and smoldering resistant article of claim 4, wherein the coating composition is disposed on a single surface of the fabric.

9. The fire and smoldering resistant article of claim 4, wherein the inorganic additive comprises an inorganic hydroxide.

10. The fire and smoldering resistant article of claim 9, wherein the inorganic hydroxide comprises a metal hydroxide.

11. The fire and smoldering resistant article of claim 10, wherein the metal hydroxide comprises zinc hydroxide, aluminum hydroxide, magnesium hydroxide, or a combination comprising at least one of the foregoing metal hydroxides.

12. The fire and smoldering resistant article of claim 11, wherein the inorganic additive further comprises a surface modifier disposed on the metal hydroxide.

13. The fire and smoldering resistant article of claim 4, wherein the fabric comprises a thermoplastic fabric, a cellulosic fabric, or a combination comprising at least one of the foregoing fabrics.

14. The fire and smoldering resistant article of claim 4, wherein the reinforcing member comprises a mesh.

15. The fire and smoldering resistant article of claim 14, wherein the mesh comprises glass, carbon, or a combination comprising at least one of the foregoing meshes.

16. A fire and smoldering resistant article comprising:
a fabric;
a coating composition to provide resistance to fire and smoldering of the article, the coating composition disposed on the fabric and comprising:
a cross-linked silicone polymer that comprises:
a reaction product of cross-linking polydimethylsiloxane (PDMS);
a reaction product of cross-linking a hydroxy modified PDMS;
a reaction product of cross-linking a vinyl modified PDMS; or
a combination comprising at least one of the foregoing reaction products; and
a metal hydroxide disposed among the silicone polymer; and
a mesh interposed between the fabric and the coating composition.

17. The fire and smoldering resistant article of claim 16, wherein the mesh comprises an interstitial gap, and
a portion of the coating composition is disposed in the interstitial gap.

18. A process for making a fire and smoldering resistant article, the process comprising:
providing a cross-linkable silicone polymer;
combining an inorganic additive with the cross-linkable silicone polymer;
cross-linking the cross-linkable silicone polymer to form a cross-linked silicone polymer and a coating composition comprising:
the cross-linked silicone polymer; and
the inorganic additive disposed among the cross-linked silicone polymer; and
disposing the coating composition on a substrate to form the fire and smoldering resistant article.

19. The process of claim 18, further comprising curing the fire and smoldering resistant article at a temperature from 50° C. to 120° C. and for a time less than 2 hours.
